(19) United States
(12) Patent Application Publication
(10) Pub. No.: US 2026/0006364 A1
(43) Pub. Date: Jan. 1, 2026

(54) EARPHONES

(71) Applicant: SHENZHEN SHOKZ CO., LTD., Shenzhen, Guangdong (CN)

(72) Inventors: Yueqiang WANG, Shenzhen (CN); Yingying ZHANG, Shenzhen (CN); Song YOU, Shenzhen (CN)

(73) Assignee: SHENZHEN SHOKZ CO., LTD., Shenzhen, Guangdong (CN)

(21) Appl. No.: 19/319,719

(22) Filed: Sep. 4, 2025

Related U.S. Application Data
(63) Continuation of application No. PCT/CN2024/076069, filed on Feb. 5, 2024.

(51) Int. Cl. H04R 1/08; H04R 1/10

(52) U.S. Cl. CPC H04R 1/083; H04R 1/1008; H04R 1/1033; H04R 1/1041; H04R 2201/107

(57) ABSTRACT

Provides an earphone including a wearing component, a speaker component, and a stick microphone component. The wearing component is connected to the speaker component, and the stick microphone component is rotatably disposed on the speaker component around a preset axis. The stick microphone component includes a stick assembly and a microphone assembly. The microphone assembly is fixedly connected to the stick assembly. The stick assembly is configured to position the microphone assembly in a sound pickup area corresponding to a mouth of a user when the earphone is in a wearing state. The stick assembly includes an elastic sheet and an elastic covering body covering the elastic sheet, the elastic sheet has a thickness direction and a width direction perpendicular to each other, the elastic sheet includes a smaller size in the thickness direction than in the width direction. The thickness direction is set toward or away from a face of the user in the wearing state. By the above, it is possible to make the structure of the stick microphone component more flexible.

### CROSS-REFERENCE TO RELATED APPLICATIONS

This application is a continuation of International Patent Application No. PCT/CN2024/076069, filed on Feb. 5, 2024, the entire contents of which are incorporated herein by reference.

### TECHNICAL FIELD

This application relates to the technical field of electronic devices, and in particular, to earphones.

### BACKGROUND

With the continuous popularization of electronic devices, electronic devices have become indispensable social and entertainment tools in daily life, and people's requirements for electronic devices are also getting higher and higher. Electronic devices such as earphones and smart glasses have also been widely used in people's daily life, which can be used in conjunction with cell phones, computers, and other terminal devices in order to facilitate the provision of auditory experiences for users. However, the current stick microphone component of earphones suffers from poor structural flexibility.

### SUMMARY

The present disclosure provides an earphone including a wearing component, a speaker component, and a stick microphone component. The wearing component is connected to the speaker component, and the stick microphone component is rotatably disposed on the speaker component about a preset axis. The stick microphone component includes a stick assembly and a microphone assembly. The microphone assembly is fixedly connected to the stick assembly. The stick assembly is configured to position the microphone assembly in a sound pickup area corresponding to a mouth of a user when the earphone is in a wearing state. The stick assembly includes an elastic sheet and an elastic covering body covering the elastic sheet, the elastic sheet has a thickness direction and a width direction perpendicular to each other, and the elastic sheet has a smaller dimension in the thickness direction than in the width direction. The thickness direction is set toward or away from a face of the user in the wearing state.

In some embodiments, the stick assembly is rotatable about the preset axis relative to the speaker component. The elastic sheet includes two edges disposed opposite to each other in the width direction, the elastic sheet is configured such that when the elastic sheet rotates around a rotation direction of the preset axis, one edge of the two edges is located in front of the rotation direction, and the other edge of the two edges is located in rear of the rotation direction.

In some embodiments, an angle between the width direction and the preset axis is ≥80° and ≤90°. And/or, a rotation angle of the stick assembly in the rotation direction is in a range of 0˜135°.

In some embodiments, one end of the stick assembly is connected to a speaker component, and the other end of the stick assembly is connected to the microphone assembly. In a natural state, the elastic sheet gradually bends toward the face of the user from an end of the elastic sheet close to the speaker component to the other end of the elastic sheet away from the speaker component.

In some embodiments, the ratio of a dimension of the elastic sheet along the thickness direction to a dimension along the width direction is 0.1 to 0.3. And/or, the elastic sheet is a titanium sheet.

In some embodiments, the microphone assembly is fixedly connected to an end of the stick assembly away from the preset axis. The microphone assembly includes a housing, a microphone, a microphone circuit board, and a button module. The housing is provided with an accommodating cavity and a microphone hole connected to the accommodating cavity, the microphone and the microphone circuit board are provided in the accommodating cavity, the microphone is fixed to the microphone circuit board and disposed opposite to the microphone hole. The housing includes two first shell walls disposed opposite to each other along the width direction, two second shell walls disposed opposite to each other along the thickness direction, and an end wall at one end of the housing away from the preset axis. The microphone hole is disposed on a second shell wall or the end wall, the button module is disposed on a first shell wall, and the button module is configured to control the microphone to be turned on or off.

In some embodiments, the first shell wall is provided with a button hole, the button module includes a button and an adapter circuit board, and the adapter circuit board is electrically connected to the microphone circuit board. The adapter circuit board is disposed in the accommodating cavity, the button is inserted into the button hole and blocks the button hole, the adapter circuit board is provided with a switch, and the button abuts against the switch to control the microphone to be turned on or off by pressing to trigger the switch.

In some embodiments, the button includes an elastic body and a button body abutting the elastic body, the elastic body is disposed in the accommodating cavity and blocks the button hole from the accommodating cavity, the button body is disposed on a side of the elastic body away from the accommodating cavity and exposed through the button hole. The button module includes a fixing plate, the fixing plate is supported on a side of the adapter circuit board away from the elastic body to sandwich the adapter circuit board between the fixing plate and the elastic body, and the fixing plate is fixedly disposed within the accommodating cavity.

In some embodiments, the microphone includes at least two microphones, including a first microphone and a second microphone, and the microphone hole includes at least two microphone holes, including a first microphone hole and a second microphone hole, the first microphone hole is located in the end wall, and the second microphone hole is located in the second shell wall. The first microphone and the second microphone are fixedly disposed on the microphone circuit board and correspond to the first microphone hole and the second microphone hole, respectively. The second microphone hole is located between two ends of the housing and closer to an end of the housing close to the preset axis.

In some embodiments, the housing includes a housing and a cover body. The shell includes a portion of the second shell wall to enclose an opening communicating with the accommodating cavity. The cover covers the opening to form another portion of the second shell wall. The microphone circuit board includes a first fixing plate portion and a second fixing plate portion. The first fixing plate portion is arranged opposite to the end wall for fixing the first microphone. The second fixing plate portion is arranged opposite to the second shell wall for fixing the second microphone. The cover includes a cover plate, a first support protrusion, and a second support protrusion, the first support protrusion and the second support protrusion are protrudingly arranged on a side of the cover plate facing the accommodating cavity. The first support protrusion is arranged opposite to the end wall to support the first fixing plate portion and/or the first microphone toward the end wall. The second support protrusion extends toward the second shell wall to support the second fixing plate portion and/or the second microphone.

In some embodiments, the stick assembly includes a first splice block fixedly disposed at an end of the elastic sheet away from the preset axis, the elastic covering body further extends to cover a portion of a periphery of the first splice block. The first splice block is provided with a first lead hole. The housing is provided with a first splice hole at an end of the housing close to the preset axis, the first splice block is inserted in the first splice hole, the microphone circuit board is connected to a wire, and the wire passes through the first lead hole from the accommodating cavity into the elastic covering body to lead to the speaker component.

In some embodiments, the stick microphone component includes a pivot mechanism. The stick assembly includes a second splice block fixedly disposed at an end of the elastic sheet close to the preset axis, the elastic covering body further extends to cover a portion of a periphery of the second splice block. The pivot mechanism is rotatably disposed in the speaker component around the preset axis. The pivot mechanism is provided with a second splice hole, and the second splice block is inserted in the second splice hole. The second splice block is provided with a second lead hole, and a wire of the stick microphone component is introduced from the elastic covering body into the pivot mechanism through the second lead hole and into the speaker component through the pivot mechanism.

The beneficial effect of the present disclosure is that, through the above settings, it is possible to make the structure of the stick microphone component more flexible, and at the same time, it is possible to make the microphone assembly have more freedom of movement to capture the sound more reasonably, so that it is possible to improve the compatibility of the earphone.

### BRIEF DESCRIPTION OF THE DRAWINGS

In order to more clearly illustrate the technical solutions in the embodiments of the present disclosure, the accompanying drawings to be used in the description of the embodiments will be briefly introduced below, and it will be obvious that the accompanying drawings in the following description are only some of the embodiments of the present disclosure, and other accompanying drawings can be obtained according to these drawings for those of ordinary skill in the art without putting forth creative labor.

FIG. a1 is a schematic diagram of a three-dimensional structure of an embodiment of an earphone according to the present disclosure;

FIG. a2 is a schematic diagram of a disassembled structure of an embodiment of an earphone according to the present disclosure;

FIG. a3 is a schematic diagram of wearing of an embodiment of an earphone according to the present disclosure;

FIG. 1 is a schematic diagram of a three-dimensional structure of an embodiment of an earphone according to the present disclosure;

FIG. 2 is a schematic diagram of a disassembled structure of the earphone shown in FIG. 1, in which part A20 is enlarged;

FIG. 3 is a schematic diagram of a side structure of an embodiment of an earphone according to the present disclosure;

FIG. 4 is a schematic diagram of a cross-sectional structure of the earphone shown in FIG. 1 along a section line E21-E21;

FIG. 5 is a schematic diagram of a structure of a A21 part of the earphone shown in FIG. 4;

FIG. 6 is another schematic diagram of the structure of the A21 part of the earphone shown in FIG. 4;

FIG. 7 is another schematic diagram of the structure of the A21 part of the earphone shown in FIG. 4;

FIG. 8 is another schematic diagram of the structure of the A21 of the earphone shown in FIG. 4;

FIG. 9 is a schematic diagram of a cross-sectional structure of a headband component and a telescoping component shown in FIG. 1;

FIG. 10 is a schematic diagram of a cross-sectional structure of the A22 part shown in FIG. 9;

FIG. 11 is a schematic diagram of a disassembled structure of an embodiment of an earphone according to the present disclosure after hiding part of the parts;

FIG. 12 is a schematic diagram of a disassembled structure of an earphone embodiment of the present disclosure after hiding part of the parts;

FIG. 13 is a schematic diagram of a connection structure of a stick microphone component and a speaker component;

FIG. 14 is a schematic diagram of a disassembled structure of the structure shown in FIG. 13;

FIG. 15 is the schematic diagram of a disassembled structure after hiding some parts of the structure shown in FIG. 13;

FIG. 16 is a schematic diagram of a structure including a limit groove and a limit protrusion;

FIG. 17 is a schematic diagram of a cross-section structure of a stick microphone component;

FIG. 18 is a schematic structure of a stick microphone component with some parts hidden;

FIG. 19 is a schematic diagram of a cross-section structure of a stick microphone component along a section line E91-E91;

FIG. 20 is a schematic diagram of a cross-section structure of another part of a stick microphone component and a speaker component along a E91-E91 section line;

FIG. 21 is a schematic diagram of a disassembled structure of a pivot mechanism and a button module; and

FIG. 22 is a schematic diagram of a structure of a speaker component in another cross section perpendicular to the cross section shown in FIG. 20.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by those of ordinary skill in the art without creative labor fall within the scope of protection of the present disclosure.

References to “embodiments” in the present disclosure imply that particular features, structures, or characteristics described in conjunction with the embodiments may be included in at least one embodiment of the present disclosure. It is understood by those of skill in the art, both explicitly and implicitly that the embodiments described in the present disclosure may be combined with other embodiments.

As shown in FIG. a1, an earphone 1 may include a wearing component 2, a speaker component 3, and a stick microphone component 7. Two speaker components 3 may be provided. The two speaker components 3 are used to transmit vibration and/or sound to the left ear and right ear of a user, respectively. The two speaker components 3 may be the same or different. For example, one speaker component 3 may be provided with the stick microphone component 7, and the other speaker component 3 may not be provided with the stick microphone component 7.

As shown in FIG. a2, the wearing component 2 may include a headband component 21, a telescoping component 22, and a twisting component 23. Two telescoping components 23 may be provided, and two twisting components 23 may be provided. The two ends of the headband component 21 are connected to two telescoping components 22 in a one-to-one correspondence, and the two telescoping components 22 are connected one-to-one with the two twisting components 23. The two twisting components 23 are connected one-to-one with the two speaker components 3. The headband component 21 is configured to go around the top of the head of the user, and the shape of the headband component 21 may be matched to the contour of the head of the user, which makes the user more comfortable and stable when wearing the headband component 21. The headband component 21 is also configured to elastically clamp the sides of the head of the user. The telescoping component 22 is capable of telescoping movement to change its own length, and thus the distance between the headband component 21 and the speaker component 3, and thus is adaptable according to different head shapes of the user to be able to position the speaker component 3 in a suitable location, thereby improving the compatibility of the wearing component 2. The twisting component 23 may generate elastic torsion and twist as the speaker component 3 contacts the head of the user in a wearing state, so that the speaker component 3 can better fit the face of the user or be positioned at the ear.

As described in FIG. a2, the headband component 21 may include a clamping component 210 and a first elastic covering body 212. The clamping component 210 may include an elastic sheet that may realize an elastic clamping function. The first elastic covering body 212 may include a covering body 2121 and an elastic band 2122 integrally molded with the covering body 2121. The covering body 2121 is molded to cover around the periphery of the clamping component 210 and a wire. Two ends of the elastic band 2122 are spaced apart from each other along the length direction of the clamping component 210 and are each coupled to the covering body 2121. The elastic band 2122 is separated from the covering body 2121 between the connection locations of its two ends with the covering body 2121, and the elastic band 2122 is configured to, in the wearing state, position the clamping component 210 to assist in positioning it to the head of the user.

As shown in FIG. a2, the telescoping component 22 may include a fixing portion 221 and a telescoping portion 223 telescopically disposed relative to the fixing portion 221, and the two ends of the clamping component 210 are respectively fixed with the corresponding fixing portions 221, which may be, for example, by plug-in fixation. The telescoping component 22 may include a decorative portion 224, the fixing portion 221 being provided with a sliding groove 2203, and a telescoping portion 223 being slidably provided in the sliding groove 2203. The decorative portion 224 is assembled and secured (e.g., capped together) with the fixing portion 221 to cover the slide 2203 and the portion of the telescoping portion 223 disposed within the slide 2203.

As shown in FIG. a2, the twisting component 23 may include an elastic connecting member 231, a second elastic covering body 232, and a first splice portion 233 and a second splice portion 234 disposed at both ends of the elastic connecting member 231. The elastic connecting member 231 is shown generally in dashed lines in FIG. a2. The second elastic covering body 232 is molded to enclose the periphery of the elastic connecting member 231, and the wire may be threaded within the second elastic covering body 232. The first splice portion 233 is mated with a splice hole 310 of the speaker component 3, and the second splice portion 234 is mated with a splice hole (not labeled) of the telescoping portion 223.

As shown in FIG. a2, the speaker component 3 may include a shell assembly 30, a bone conduction speaker 40, and an air conduction speaker 50. The speaker component 3 may also include at least one of a battery 61 and a control circuit board 62. The shell assembly 30 is configured to house the bone conduction speaker 40 and the air conduction speaker 50, the bone conduction speaker 40 being used to fit the face of the user and the air conduction speaker 50 being used to deliver air conduction sound waves to the ear canal of the user. While the earphone 1 is worn on the head of the user, the wearing component 2 may position the speaker component 3 in a facial region on the front side of the tragus of the user.

As shown in FIG. a2, the shell assembly 30 may include a main shell 31 and a main cover 32. The main shell 31 may have an open end, and the main cover 32 caps the open end of the main shell 31. The main cover 32 may be provided with a sound outlet (not labeled) for the air conduction speaker 50 to produce sound. A portion of the bone conduction speaker 40 may be exposed through the open end of the main shell 31 for fitting to the face of the user. The vibration directions of the bone conduction speaker 40 and the air conduction speaker 50 may be perpendicular to each other and assembled on the main shell 31 in a manner in which the vibration directions are perpendicular to each other to minimize the mutual interference between the bone conduction speaker 40 and the air conduction speaker 50. The bone conduction speaker 40 may be provided with an auxiliary face-fitting component 44 for face-fitting comfort. The auxiliary face-fitting component 44 is configured to increase the contact area between the bone conduction speaker 40 and the face of the user in the wearing state, enhancing the wearing comfort. The auxiliary face-fitting component 44 may include a rigid support member 441 and a soft fitting member 442. The rigid support member 441 is configured to support the soft fitting member 442 to improve the structural strength and stability of the auxiliary face-fitting component 44. The soft fitting member 442 is configured to fit the face of the user toward the face of the user, and can fit the face of the user more stably and tightly with the support of the rigid support member 441.

As shown in FIG. a2, the speaker component 3 may include at least one of the control circuit board 62 and the battery 61. For example, one speaker component 3 may include the control circuit board 62, and another speaker component 3 may not include the control circuit board 62, but may include the battery 61. The connecting wire between the two speaker components 3 may be threaded across the wearing component 2. For example, the one speaker component 3 may include both the control circuit board 62 and the battery 61. Or, two control circuit boards 62 may be provided, and each speaker component 3 may also include one control circuit board 62. Two batteries 61 may be provided, and each speaker component 3 may include one battery 61.

The stick microphone component 7 is provided in a rotatable manner on the speaker component 3. The stick microphone component 7 may include a stick assembly 70, a microphone assembly 80, and a pivot mechanism 91. The microphone assembly 80 and the pivot mechanism 91 may be connected to both ends of the stick assembly 70, and the pivot mechanism 91 is rotatably connected to the speaker component 3. In the wearing state, the pivot mechanism 91 may position the microphone assembly 80 in a pickup area of the mouth of the user by rotating relative to the speaker component 3. The microphone assembly 80 is provided with at least one microphone and an associated button, which enables the microphone to be turned on or off.

In the fields of medicine and anatomy, three basic sections of the human body may be defined: the Sagittal Plane, Coronal Plane, and Horizontal Plane, and the three basic axes of the Sagittal Axis, Coronal Axis, and Vertical Axis. The sagittal plane refers to a section perpendicular to the ground made along the anterior-posterior direction of the body, which divides the human body into left and right parts. The coronal plane is a section perpendicular to the ground made along the left and right directions of the body, which divides the body into front and back parts. The horizontal plane is a section parallel to the ground made along the upper and lower directions of the body, which divides the body into upper and lower parts. Correspondingly, a sagittal axis SA is an axis made along the anterior-posterior direction of the body and perpendicular to the coronal plane, a coronal axis is an axis made along the left-right direction of the body and perpendicular to the sagittal plane, and a vertical axis VA is an axis made along the up-and-down direction of the body and perpendicular to the horizontal plane. As shown in FIG. a3, the earphone 1 is worn with the wearing component 2 clamped to the sides of the head of the user, and the speaker component 3 is located in the face region in front of the tragus along the sagittal axis SA.

The following will describe the earphone 1 or some of the above mentioned components, structures, etc. in detail, and of course, some of the above mentioned structures, components, such as the bone conduction speaker 40, the air conduction speaker 50, etc. may be used not only on the earphone 1, but also on other electronic devices, such as cell phones, speakers, smart wearable devices, or the like.

The following describes an exemplary structure of the earphone 1 for the earphone embodiment of the present disclosure.

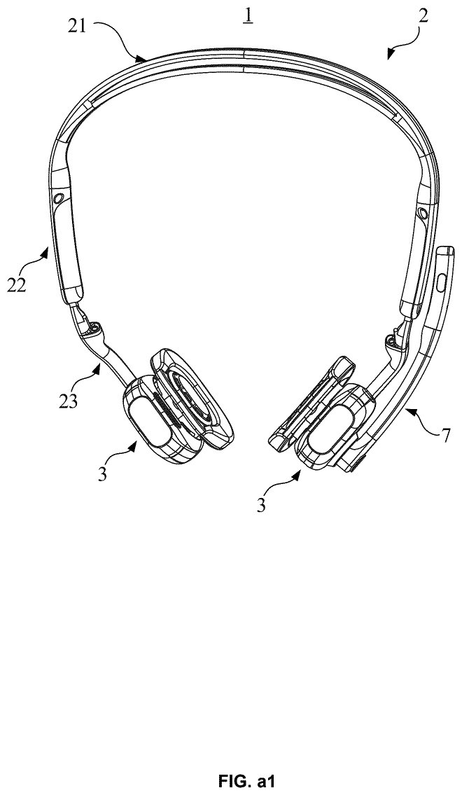

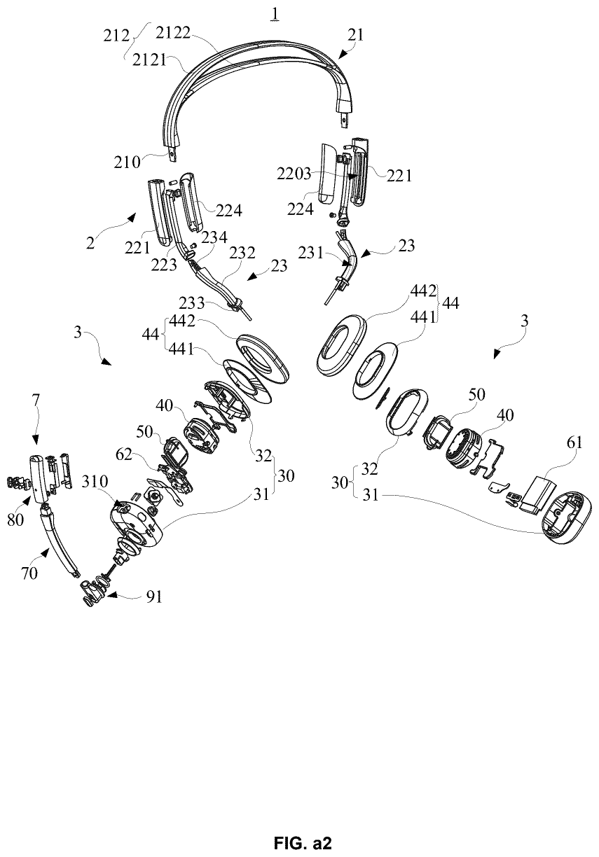

As shown in FIG. 1 to FIG. 4, in some embodiments, the earphone 1 includes the wearing component 2 and the speaker component 3 connected to the wearing component 2, the wearing component 2 being used to position the speaker component 3 at the front side of the tragus of the user in the wearing state. The front side of the tragus is the side of the tragus near the nose.

The speaker component 3 is available in the area of the face on the front side of the tragus of the user, which transmits sound to the human ear through the speaker. Two speaker components 3 may be provided. The two speaker components 3 are used to transmit vibration and/or sound to the left ear and right ear of the user, respectively. The two speaker components 3 may be the same or different. The earphone 1 may also include the stick microphone component 7, and the stick microphone component 7 may be provided on one of the speaker components 3. The stick microphone component 7 may be configured to trigger the speaker component 3 to operate, and the stick microphone component 7 may also be configured to capture sound. The speaker component 3 may include at least one of a bone conduction speaker and an air conduction speaker.

The wearing component 2 may be able to hook the speaker component 3 to a face region on the front side of the tragus of the user, and the wearing component 2 may also apply a force to the speaker component 3 to cause the speaker component 3 to fit to the face region on the front side of the tragus of the user. Specifically, the wearing component 2 is configured to wrap around the top of the head of the user and may cause the speaker component 3 to be positioned overall on the front side of the ear of the user. The shape of the wearing component 2 may be matched to the contour of the head of the user, which makes it more comfortable and stable for the user to wear the earphone 1. The following is an exemplary structure of the wearing component 2 of the present disclosure.

As shown in FIG. 1 through FIG. 4, the wearing component 2 may include the headband component 21, and the headband component 21 includes the clamping component 210, a wire 211b, and the first elastic covering body 212. The clamping component 210 has a length direction Lt, a thickness direction Ht, and a width direction Wt, and the clamping component 210 is disposed in a curved shape along the length direction Lt to allow the headband component 21 to be disposed around the periphery of the top of the head of the user in the wearing state and to provide a clamping force. The dimension of the clamping component 210 along the width direction Wt is larger than the dimension along the thickness direction Ht, and the thickness direction Ht is oriented toward or away from the head of the user in the wearing state. The first elastic covering body 212 includes a covering body 2121 that is molded to enclose a periphery of the clamping component 210 and the wire 211b, and the clamping component 210 and the wire 211b disposed within the covering body 2121 overlap at least partially along the thickness direction Ht. Overlapping at least partially of the clamping component 210 and the wire 211b along the thickness direction Ht may mean that the clamping component 210 and the wire 211b are at least partially level with each other along the thickness direction Ht.

Specifically, the clamping component 210 may be deformed under an external force during wearing of the headband component 21, and a stress may be generated within the clamping component 210, causing the clamping component 210 to have a clamping effect, which may improve the stability of the headband component 21.

By setting the dimension of the clamping component 210 in the width direction Wt to be larger than the dimension of the clamping component 210 in the thickness direction Ht, the dimension of the clamping component 210 in the thickness direction Ht is smaller, so that a more stable oriented elastic deformation can occur in the direction of the head of the user when the clamping component 210 is deformed, which reduces the elastic deformation of the clamping component 210 in the width direction Wt, and thereby facilitates molding of the clamping component 210 while making the headband component 21 easy to wear. The larger dimension of the clamping component 210 along the width direction Wt allows the clamping component 210 to maintain sufficient clamping force, and at the same time facilitates an increase in the area of action of the clamping component 210 on the top of the head of the user to improve the wearing stability of the headband component 21.

The covering body 2121 may be an elastic material with deformation capability so that it may be deformed in synchronization with the clamping component 210. By covering the covering body 2121 around the periphery of the clamping component 210 and the wire 211b in a molded manner, the assembly process of the headband component 21 can be simplified, and the structural stability of the headband component 21 can be improved. The covering body 2121 can also enhance the tactile sensation of a user contacting the headband component 21, and improve the wearing comfort of the headband component 21. The covering body 2121 can also increase the friction between the head of the user and the headband component 21 through elastic deformation, reduce the risk of sliding of the headband component 21 during wearing, and improve wearing stability. For example, the covering body 2121 is wrapped around the periphery of the clamping component 210 and the wires 211b in a molding manner, such as injection molding or compression molding, etc. The material of the headband component 21 may include silicone, rubber, or the like, for example, the covering body 2121 is made of silicone or rubber.

The mechanical strength of the clamping component 210 is higher than that of the wire 211b. By partially overlapping the clamping component 210 and the wire 211b in the thickness direction Ht, the tensile or compressive effect of the clamping component 210 on the wire 211b when the clamping component 210 deforms can be reduced. This improves the service life of the wire 211b and ensures a higher consistency in the deformation of both the clamping component 210 and the wire 211b, thereby enhancing the structural stability of the wearing component 2.

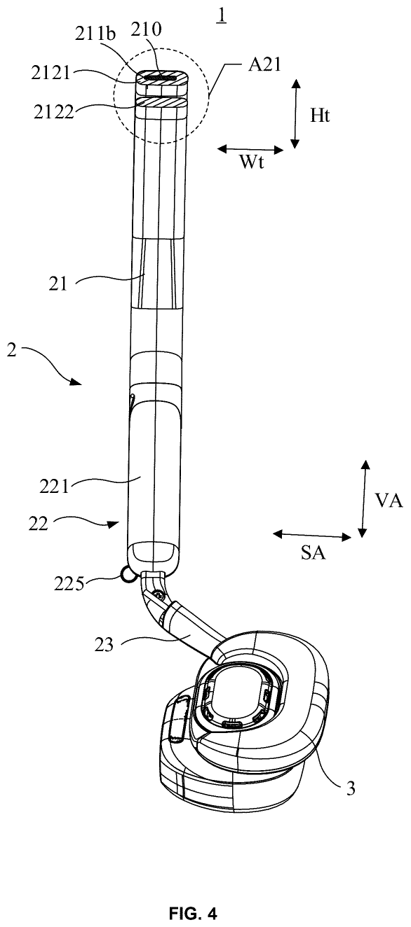

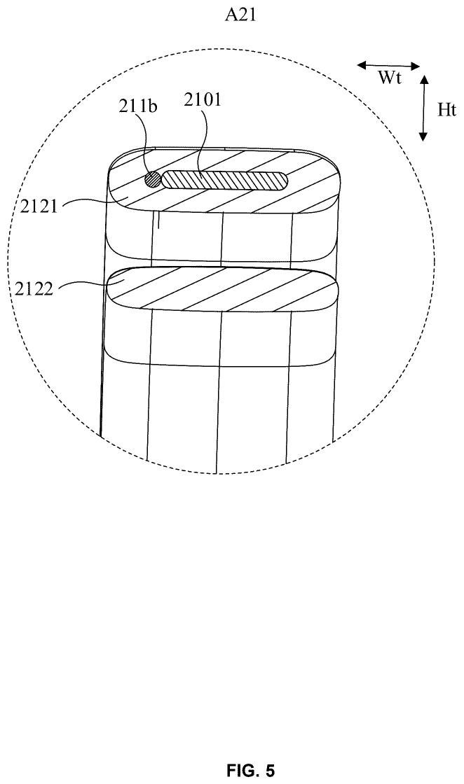

In some embodiments, as shown in FIG. 4 and FIG. 5, the ratio of the overlap dimension of the clamping component 210 and the wire 211b along the thickness direction Ht to the minimum of the dimension of the clamping component 210 along the thickness direction Ht and the dimension of the wire 211b along the thickness direction Ht is between 0.6 and 1. In some embodiments, the ratio may also be between 0.7 and 0.9.

Specifically, in some embodiments, the dimension of the clamping component 210 along the thickness direction Ht is greater than or equal to the dimension of the wire 211b along the thickness direction Ht, and the ratio of the overlap dimension of the clamping component 210 and the wire 211b along the thickness direction Ht to the dimension of the dimension of the wire 211b along the thickness direction Ht is between 0.6 and 1. For example, the ratio of the overlapping dimension of the clamping component 210 and the wire 211b along the thickness direction Ht to the dimension of the wire 211b along the thickness direction Ht is 0.7, 0.8, or 0.9.

In other embodiments, the dimension of the clamping component 210 along the thickness direction Ht are smaller than the dimension of the wire 211b along the thickness direction Ht, and the ratio of the overlapping dimension of the clamping component 210 and the wire 211b along the thickness direction Ht to the dimension of the clamping component 210 along the thickness direction Ht is between 0.6 and 1. For example, the ratio of the overlapping dimension of the clamping component 210 and the wire 211b along the thickness direction Ht to the dimension of the clamping component 210 along the thickness direction Ht is 0.7, 0.8, or 0.9.

With such a configuration, it can make the clamping component 210 and the wire 211b have more overlap along the thickness direction Ht, which is conducive to the synchronous deformation of the wire 211b with the clamping component 210, this can reduce the stretching or squeezing effect on the wire 211b when the clamping component 210 is deformed, and improve the service life of the wire 211b. At the same time, more overlap of the clamping component 210 and the wire 211b along the thickness direction Ht is conducive to reducing the dimension of the headband component 21 along the thickness direction Ht, and to promoting the overall thinness of the headband component 21. If the ratio is small, the deformation of the clamping component 210 results in excessive stretching or squeezing of the wire 211b, which is also detrimental to the overall thinning of the headband component 21.

In some embodiments, as shown in FIG. 4 and FIG. 5, the ratio of the dimension of the clamping component 210 along the thickness direction Ht to the dimension of the wire 211b along the thickness direction Ht is between 0.5 and 2. In some embodiments, the ratio may be between 0.8 and 1.8. In some embodiments, the ratio may be between 1.1 and 1.6. For example, the ratio of the dimension of the clamping component 210 along the thickness direction Ht to the dimension of the wire 211b along the thickness direction Ht is 0.7, 0.9, 1.0, 1.2, 1.5, or 1.8. In some embodiments, the ratio of a dimension of the clamping component 210 along the thickness direction Ht to a dimension of the wire 211b along the thickness direction Ht is between 0.8 and 1.2.

If this ratio is smaller, the clamping component 210 overlaps less with the wire 211b along the thickness direction Ht, and the deformation of the clamping component 210 results in an excessive tensile or squeezing action on the wire 211b. If this ratio is larger, it will result in a larger dimension and greater weight of the headband component 21, which will reduce the wearing comfort of the user and will not be conducive to the overall lightness of the headband component 21. Thus, setting the above ratio range in this manner can make the difference between the dimension of the clamping component 210 along the thickness direction Ht and the dimension of the wire 211b along the thickness direction Ht within a certain reasonable range, which is conducive to increasing the deformation consistency of the clamping component 210 and the wire 211b, thereby reducing the stresses on the wire 211b, while ensuring the overall thinness of the headband component 21.

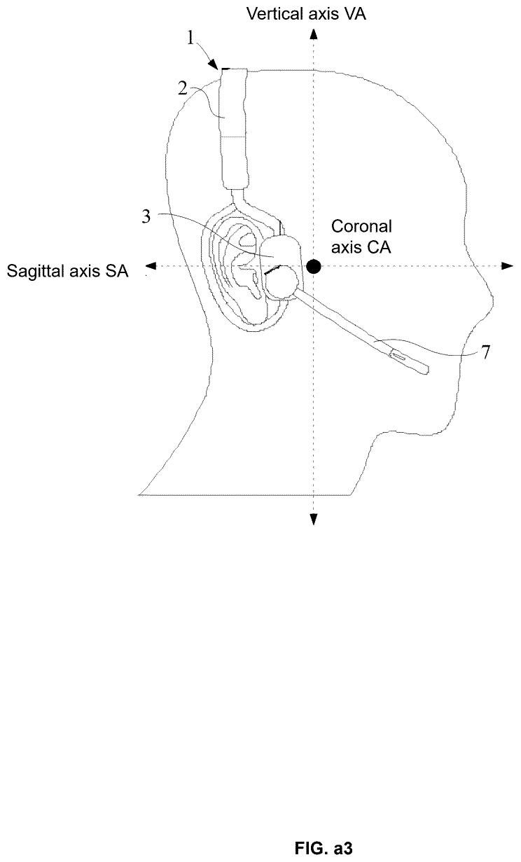

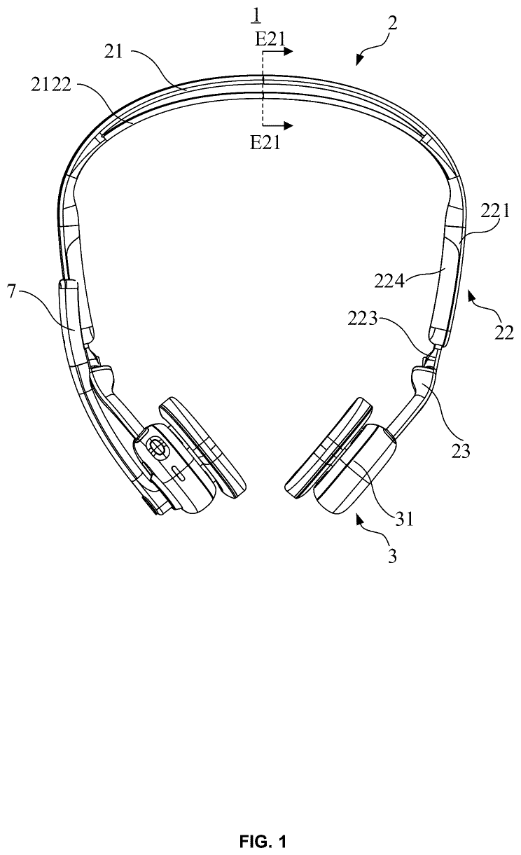

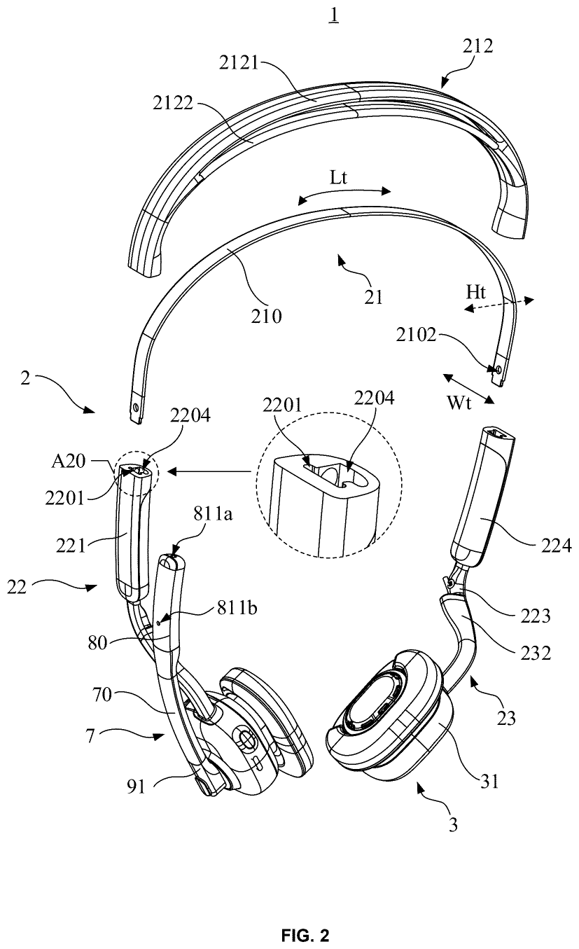

In some embodiments, as shown in FIG. 1 and FIG. 2, the first elastic covering body 212 further includes an elastic band 2122 integrally molded with the covering body 2121, the two ends of the elastic band 2122 being spaced apart from each other along the length direction Lt and respectively connected to the covering body 2121. The elastic band 2122 is separated from the covering body 2121 between the connection positions of its two ends with the covering body 2121, and the elastic band 2122 is configured to assist in positioning the clamping component 210 to the head of the user in the wearing state.

The clamping component 210 is stronger in stiffness than the elastic band 2122, and the ability of the clamping component 210 to bend and deform is less than the elastic band 2122. The elastic band 2122 is flexible and easily conforms to the head of the user for increased wearing comfort. By setting the elastic band 2122, the headband component 21 can obtain more freedom in structure, which can improve the covering effect of the headband component 21 on the head of the user, and thus increase the friction, which in turn improves the wearing stability of the headband component 21. The material of the elastic band 2122 itself can also increase the friction between the head of the user and the headband component 21, reduce the risk of sliding of the headband component 21 during the wearing process, and improve the wearing stability. In addition, the elastic band 2122 when elastically deformed can also provide a clamping force to strengthen the clamping effect of the headband component 21.

The assembly process can be simplified by integrally molding the covering body 2121 with the elastic band 2122. By setting the elastic band 2122 and the covering body 2121 separate from each other, the elastic band 2122 can be made more flexible in deformation, and the functional effect of an elastic sheet 2101 can be enhanced. In some embodiments, the elastic band 2122 and the covering body 2121 may have a spacing between the elastic band 2122 and the covering body 2121, so as to provide space for the deformation of the elastic band 2122, while the elastic band 2122 is positioned closer to the head of the user, so as to enhance the stability of wearing.

For example, the covering body 2121 and the elastic band 2122 are integrally molded by injection molding or compression molding, etc. The material of the elastic band 2122 may include silicone, rubber, or the like.

In some embodiments, as shown in FIG. 4 and FIG. 5, the wearing component 2 is configured to position the speaker component 3 at or near the ear of the user in the sound reception area in the direction of the sagittal axis SA while in the wearing state. The speaker component 3 is positioned nearer to the side of the face compared to the clamping component 210, and the wire 211b is positioned nearer to the back of the head compared to the clamping component 210.

With this configuration, the clamping component 210 can be made closer to the speaker component 3 along the direction of the sagittal axis SA, which is conducive to improving the effect of the clamping component 210 in positioning the speaker component 3, and making the wearing of the speaker component 3 more stable. And, the wire 211b is closer to the back side of the head compared to the clamping component 210, so that the clamping component 210 is closer to the front side of the head, and the strength of the side closer to the front side of the head is higher, so that it is better clamped to the head of the user and can reduce the possibility of the headband component 21 slipping off when the user lowers his or her head.

In some embodiments, as shown in FIG. 4 and FIG. 5, the clamping component 210 includes the elastic sheet 2101, and the wire 211b is disposed laterally of the elastic sheet 2101 along the width direction Wt and at least partially overlaps the elastic sheet 2101 along the thickness direction Ht.

With this configuration, it is advantageous to reduce the dimension of the headband component 21 along the thickness direction Ht, so as to make the headband component 21 overall thinner and lighter. The sheet-like structure of the elastic sheet 2101 is easy to mold in the manufacturing process, with a high yield rate. The dimension of the elastic sheet 2101 along the width direction Wt may be larger than the dimension along the thickness direction Ht, and by configuring the elastic sheet 2101, strain and stress may be generated inside the elastic sheet 2101 when the headband component 21 is worn, causing the elastic sheet 2101 to have a clamping effect, thereby improving the wearing stability of the headband component 21.

By molding the covering body 2121 over the periphery of the elastic sheet 2101 and the wire 211b, the assembly process of the headband component 21 can be simplified, and the structural stability of the headband component 21 can be improved. By configuring the elastic sheet 2101 and the wire 211b to overlap at least partially along the thickness direction Ht, the stretching or squeezing effect on the wire 211b during deformation of the elastic sheet 2101 can be reduced, the elastic sheet 2101 and the wire 211b have a high consistency in deformation, improving the structural stability of the headband component 21, and thereby improving the service life of the wire 211b.

In some embodiments, the elastic sheet 2101 may be a titanium sheet, a spring steel sheet, or a carbon fiber sheet.

In some embodiments, the elastic sheet 2101 has a dimension range of 0.65 to 2 mm along the thickness direction Ht. Furthermore, the dimension of the elastic sheet 2101 along the thickness direction Ht ranges from 0.8 to 1.6 mm or from 1.65 to 1.8 mm, such as the dimension of the elastic sheet 2101 along the thickness direction Ht is 0.83 mm, 0.85 mm, or 0.87 mm.

If the dimension of the elastic sheet 2101 along the thickness direction Ht is larger, it will result in a larger dimension and greater weight of the headband component 21, which will reduce the comfort of wearing for the user, and will not be conducive to the overall lightness of the headband component 21. If the dimension of the elastic sheet 2101 along the thickness direction Ht is small, on the one hand, the elastic sheet 2101 is not able to provide sufficient clamping force, and on the other hand, it will result in the wire 211b being subjected to excessive stretching or compression effect when the elastic sheet 2101 is deformed. Thus, setting the above dimension range in such a manner, on the one hand, it is conducive to the overall thinness of the headband component 21, making the user comfortable to wear, and on the other hand, it is conducive to the elastic sheet 2101 playing the role of clamping the head of the user and reducing the tension or extrusion of the wire 211b, so that the wire 211b can be protected when the elastic sheet 2101 is deformed.

In some embodiments, the portion of the wire 211b within the covering body 2121 includes a wire harness, which has a dimension along the thickness direction Ht in the range of 1 to 2.5 mm. For example, the portion of the wire harness has a dimension along the thickness direction Ht in the range of 1.2 to 2 mm, such as the portion of the wire harness has a dimension along the thickness direction Ht in the range of 1.2 mm, 1.3 mm, 1.5 mm, or 1.6 mm.

In some embodiments, the portion of the wire 211b within the covering body 2121 includes the wire harness and an insulated wire harness channel for covering the wire harness. In some embodiments, the wire harness is movably encased within the insulated wire harness channel.

If the dimension of the wire 211b along the thickness direction Ht is large, this can result in the wire 211b being susceptible to stretching or crushing. If the dimension of the wire 211b along the thickness direction Ht is small, this results in the wire 211b being mechanically weaker and less conductive. Thus, setting the above range of dimensions is conducive to maintaining a good and stable working state of the wire 211b and extending the service life of the wire 211b.

In some embodiments, the exposed portion of the wire 211b is a wire harness wrapped by an insulating skin, and the thickness of the portion of the wire harness has a dimension range of 1.6 to 2.4 mm, and the thickness of the portion of the wire harness has a dimension 1.8 mm, 2 mm, or 2.2 mm. The insulating skin may provide an insulating and aesthetic effect. Setting up in this way can make the thickness of the insulating skin moderate and can improve the working stability of the insulating skin. If the insulating skin is too thin, it will result in the insulating skin being easily broken, and if the insulating skin is too thick, it will result in a waste of the insulating skin material while affecting the aesthetic appearance.

In some embodiments, during the assembly process, the wire 211b and the elastic sheet 2101 may be adhered with glue so that the wire 211b is shaped, and then the covering body 2121 may be applied to cover the wire 211b and the elastic sheet 2101.

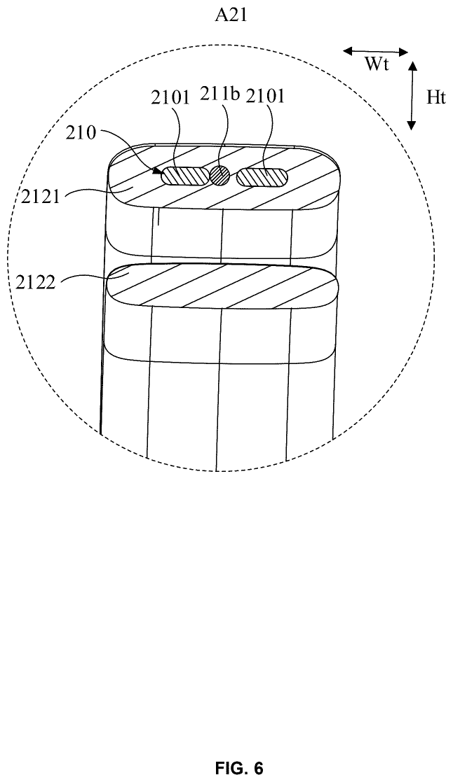

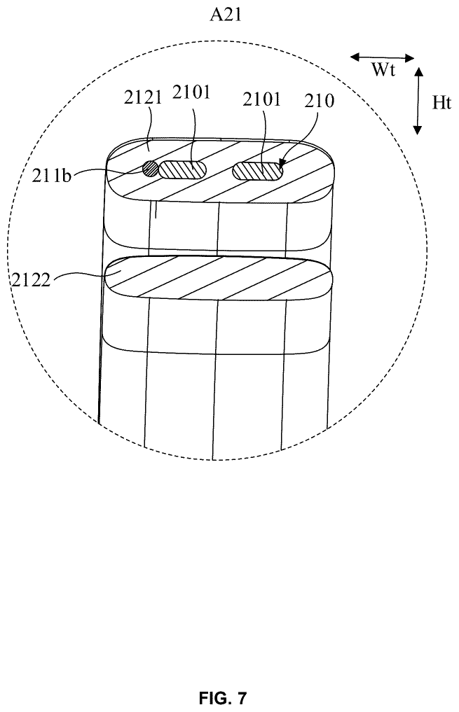

In some embodiments, as shown in FIG. 4, FIG. 6, and FIG. 7, the clamping component 210 includes two elastic sheets 2101 disposed side-by-side in the width direction Wt, and the wire 211b is disposed between the two elastic sheets 2101 in the width direction Wt or on a side of one of the two elastic sheets 2101 away from the other, and along the thickness direction Ht, the wire 211b overlaps at least partially with each of the two elastic sheets 2101.

By providing the two elastic sheets 2101, the clamping force of the clamping component 210 can be enhanced, so that the clamping component 210 is easy to be deformed while obtaining sufficient clamping force, thereby improving the wearing effect. The wire 211b is disposed between the two elastic sheets 2101 along the width direction Wt or on the side of one of the two elastic sheets 2101 away from the other, which provides the clamping component 210 with sufficient support for the clamping component 210 while providing effective protection for the wire 211b due to the increased strength and elasticity. In some embodiments, if the wire 211b is provided between the two elastic sheets 2101 in the width direction Wt, the two elastic sheets 2101 may act as a support frame when the headband component 21 is deformed, thereby providing protection for the wire 211b.

In some embodiments, the wire 211b along the sagittal axis SA direction is disposed on the side of the two elastic sheets 2101 which are away from the speaker component 3, which is conducive to improving the positioning effect of the clamping component 210 on the speaker component 3.

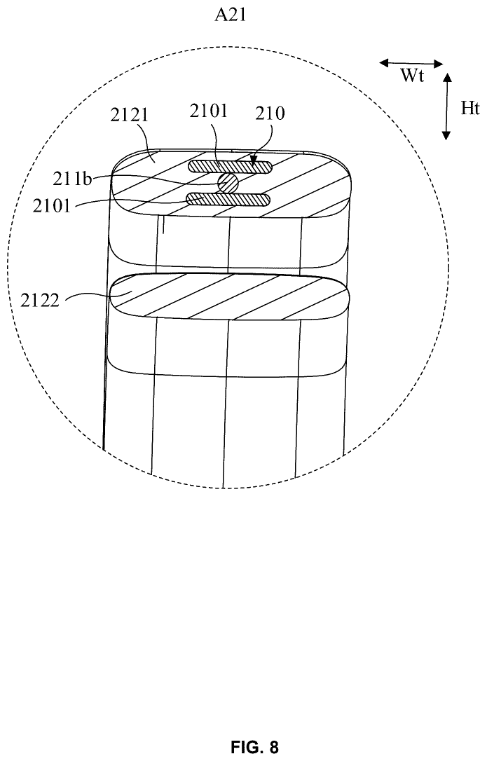

In some embodiments, as shown in FIG. 4 and FIG. 8, the clamping component 210 includes two elastic sheets 2101 stacked along the thickness direction Ht, and the wire 211b is sandwiched between the two elastic sheets 2101.

By providing the two elastic sheets 2101, the clamping component 210 can be made easy to deform while obtaining sufficient clamping force, thereby improving the wearing effect. When the wire 211b is set between the two elastic sheets 2101 along the thickness direction Ht, the two elastic sheets 2101 can act as a support frame when the headband component 21 is deformed, thereby playing a protective role for the wire 211b, which is conducive to improving the structural stability of the headband component 21.

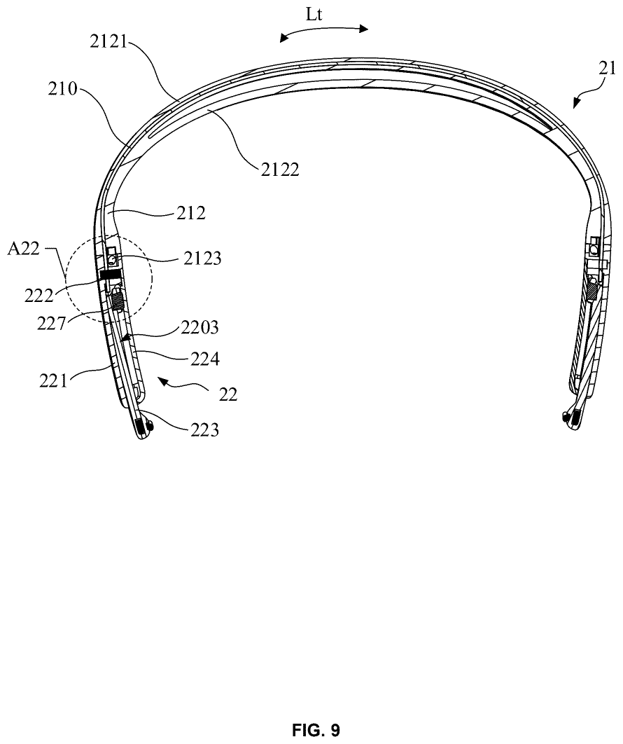

In some embodiments, as shown in FIG. 1 and FIG. 9, both ends of the clamping component 210 are exposed from the first elastic covering body 212, and the wearing component 2 further includes the telescoping component 22, wherein the telescoping component 22 and the clamping component 210 are assembled and fixed at an exposed end portion of the first elastic covering body 212.

The telescoping component 22 may be coupled between the speaker component 3 and the headband component 21, and the telescoping component 22 may telescope under an external force, and the telescoping component 22 may undergo a length change through telescoping, which may cause the distance between the speaker component 3 and the headband component 21 to change. By setting the telescoping component 22, the structure of the wearing component 2 is more flexible, and the wearing component 2 can be adaptively adjusted according to the different head shapes of different users when they wear the earphone 1, to be able to locate the speaker component 3 in a suitable position, thereby improving the compatibility of the wearing component 2.

The stiffness and hardness of the clamping component 210 is stronger than that of the first elastic covering body 212, and by setting the telescoping component 22 and the clamping component 210 are assembled and fixed at an exposed end portion of the first elastic covering body 212, it can facilitate the assembly and connection of the telescoping component 22 and the headband component 21 and improve the connection effect.

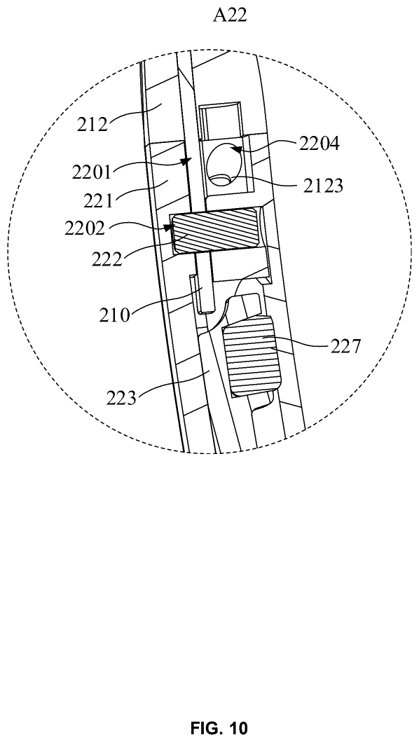

In some embodiments, as shown in FIG. 1, FIG. 9 to FIG. 11, the telescoping component 22 includes the fixing portion 221, a catch member 222, and the telescoping portion 223, and the fixing portion 221 is provided with a first splice hole 2201 and a first catch hole 2202 connected to the first splice hole 2201. The end portion of the clamping component 210 is inserted into the first splice hole 2201, the catch member 222 is inserted into the first catch hole 2202, and the end portion of the clamping component 210 is clamped into the first splice hole 2201.

In some embodiments, the telescoping portion 223 may telescope to change the length of the telescoping component 22. In other embodiments, the telescoping portion 223 may be movable relative to the fixing portion 221 to change the length of the telescoping component 22.

With this configuration, it is easy to carry out the assembly and connection between the clamping component 210 and the telescoping component 22. For example, during the assembly connection, the end portion of the clamping component 210 may be inserted into the first splice hole 2201, and then the catch member 222 may be inserted into the first catch hole 2202. As another example, the end portion of the clamping component 210 may be deformed to be inserted into the first splice hole 2201 by means of a snap.

In some embodiments, as shown in FIG. 1, FIG. 9 to FIG. 11, the telescoping component 22 further includes the decorative portion 224, the fixing portion 221 is provided with the sliding groove 2203, and the telescoping portion 223 is slidably provided within the sliding groove 2203, the first catch hole 2202 and the sliding groove 2203 are provided on the side of the fixing portion 221 facing the user in the wearing state, and the decorative portion 224 is assembled and fixed with the fixing portion 221 to cover the first catch hole 2202, the sliding groove 2203, and the portion of the telescoping portion 223 disposed within the sliding groove 2203.

The telescoping portion 223 is movable relative to the fixing portion 221 in the extension direction of the sliding groove 2203. The decorative portion 224 may obscure the first catch hole 2202, the sliding groove 2203, and the portion of the telescoping portion 223 disposed within the sliding groove 2203 to enhance the appearance. The decorative portion 224, when assembled with the fixing portion 221, may also serve as a restriction to limit the catch member 222 from sliding out of the first catch hole 2202 and to limit the telescoping portion 223 from sliding out of the sliding groove 2203.

In some embodiments, as shown in FIG. 1, FIG. 9 to FIG. 11, the telescoping component 22 further includes a damping member 227 secured to the portion of the telescoping portion 223 disposed in the sliding groove 2203, and the damping member 227 is further coupled to the decorative portion 224. The telescoping portion 223 may slide under the action of an external force, and the damping member 227 is configured to increase the sliding resistance of the telescoping portion 223 when it slides between the decorative portion 224 and the fixing portion 221, so that the telescoping portion 223 may remain at the position after sliding. Furthermore, the damping member 227 is embedded in the portion of the telescoping portion 223 disposed within the sliding groove 2203.

In some embodiments, as shown in FIG. 1, FIG. 9 to FIG. 11, the end portion of the clamping component 210 is arranged in a sheet-like manner, and it is provided with a second catch hole 2102 that penetrates both sides of the main surface of the end portion of the clamping component 210. When the end portion of the clamping component 210 is inserted within the first splice hole 2201, the first catch hole 2202 and the second catch hole 2102 align, and the catch member 222 is a pin inserted within the first catch hole 2202 and the second catch hole 2102. The first elastic covering body 212 further includes an embedded portion 2123 integrally molded with the covering body 2121, the embedded portion 2123 being abutted against a main surface on one side of the end portion of the clamping component 210, the fixing portion 221 is provided with a second splice hole 2204 connected to the first splice hole 2201, and the embedded portion 2123 is inserted into the second splice hole 2204.

By setting the end portion of the clamping component 210 in the shape of a sheet, it is possible to make the end portion of the clamping component 210 match the shape of the portion of the clamping component 210 that is within the covering body 2121, to facilitate the molding of the clamping component 210, and to facilitate the molding of the second stop hole 2102. By providing the catch member 222 as a pin inserted in the first catch hole 2202 and the second catch hole 2102, the end portion of the clamp component 210 and the fixing portion 221 can be connected more firmly.

By affixing the embedding portion 2123 to a side main surface of the end portion of the clamping component 210, the embedding portion 2123 can restrict the relative movement of the end portion of the clamping component 210 and the fixing portion 221 in a direction perpendicular to the main surface of the end portion of the clamping component 210, and the embedding portion 2123 can also limit the deformation of the end portion of the clamping component 210, reduce the risk of fracture of the end portion of the clamping component 210, and thereby enhance the stability of the connection structure of the end portion of the clamping component 210 and the fixing portion 221.

For example, the covering body 2121 is integrally molded with the embedded portion 2123 in a molding manner such as injection molding or compression molding.

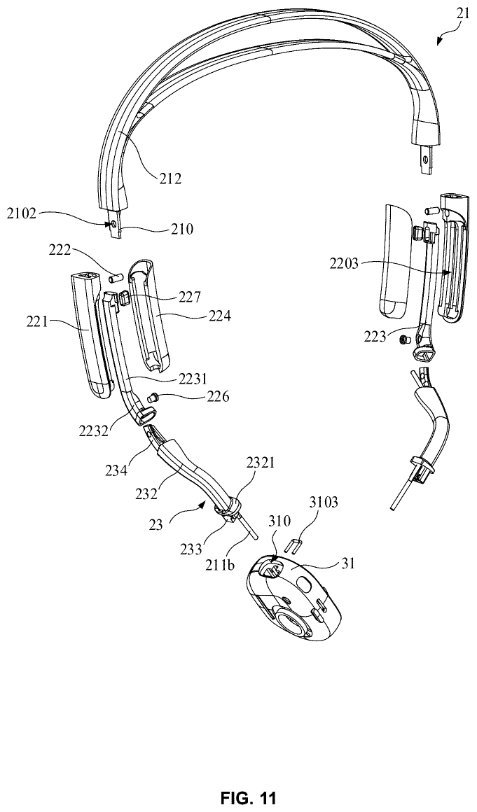

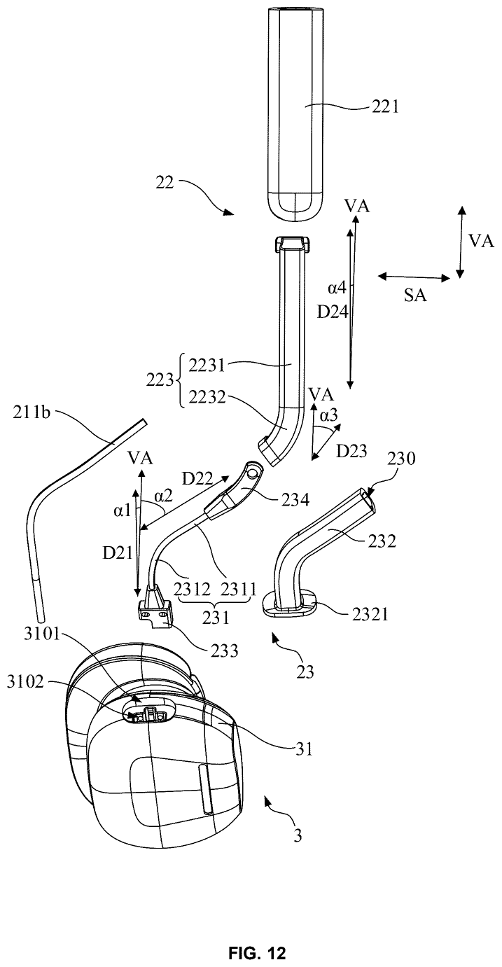

In some embodiments, as shown in FIG. 1, FIG. 11, and FIG. 12, the telescoping component 22 includes the fixing portion 221 and the telescoping portion 223 telescopically disposed relative to the fixing portion 221. The wearing component 2 further includes the twisting component 23, the twisting component 23 includes the elastic connecting member 231. One end of the elastic connecting member 231 is connected to the telescoping portion 223, and the other end of the elastic connecting member 231 is configured to connect to the speaker component 3, and the elastic connecting member 231 is itself set up to be able to torsionally deform with the speaker component 3 coming into contact with the head of the user in the wearing state.

By providing the elastic connecting member 231 to connect the telescoping component 22 and the speaker component 3, the speaker component 3 can be provided with more freedom of movement relative to the headband component 21, and the speaker component 3 can better fit the head of the user by moving relative to the headband component 21, and at the same time improve the wearing comfort of the user. After adjusting the position of the telescoping portion 223 relative to the fixing portion 221, the speaker component 3 may be movable relative to the telescoping portion 223 to better fit with the head of the user, thereby improving the compatibility of the wearing component 2 to different users.

In some embodiments, as shown in FIG. 12, the elastic connecting member 231 is an elastic metal wire.

With this configuration, the elastic connecting member 231 can be made to have good structural strength and fatigue resistance to improve the service life of the elastic connecting member 231. For example, the elastic metal wire may be a titanium wire.

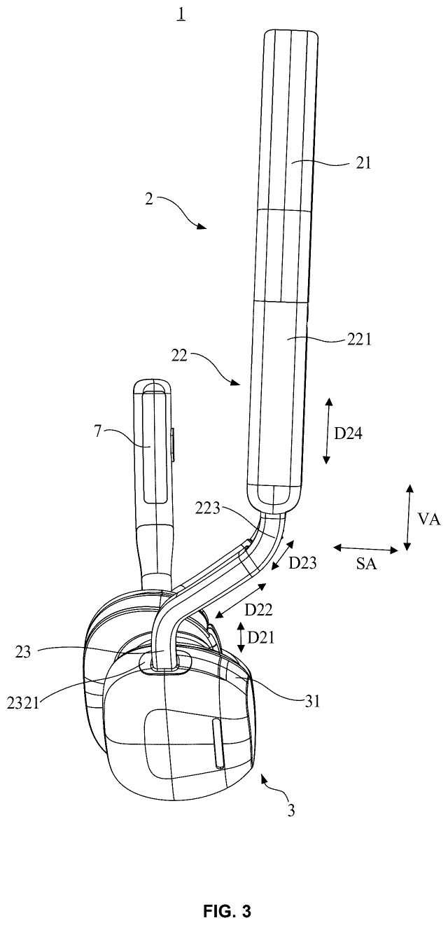

In some embodiments, as shown in FIG. 3, FIG. 11, and FIG. 12, the wire 211b extends from the exterior of the telescoping component 22 to the twisting component 23 and is secured to the twisting component 23, and the length of the wire 211b on the exterior of the telescoping component 22 is greater than the maximum elongation of the telescoping component 22.

In comparison with setting the wire 211b on the inside of the telescoping component 22, setting the wire 211b on the outside of the telescoping component 22 prevents the telescoping component 22 from interfering with the wire 211b in the process of extending and retracting the telescoping component 22, and at the same time facilitates reducing the dimension of the telescoping component 22 to improve aesthetics, and make the earphone more overall more lightweight.

The twisting component 23 guides the wire 211b to the inside of the speaker component 3. By securing the wire 211b to the twisting component 23, the twisting component 23 may limit the wire 211b, thereby facilitating the position of the wire 211b inside the speaker to remain stable. For example, interference with the position of the wire 211b inside the speaker component 3 by the telescoping process of the telescoping component 22 may be reduced.

The maximum elongation of the telescoping component 22 is a length of the telescoping component 22 when it is fully extended. By setting the length of the wire 211b external to the telescoping component 22 to be greater than the maximum elongation of the telescoping component 22, the pulling of the wire 211b by the telescoping process of the telescoping component 22 can be reduced to improve the service life of the wire 211b, and at the same time may reduce the interference of the wire 211b on the telescoping process of the telescoping component 22.

Furthermore, a channel is provided at one end of the telescoping component 22 connecting to the twisting component 23, and the wire 211b extends from the outer part of the telescoping component 22 into the hole, and then extends through the hole into the twisting component 23.

In some embodiments, as shown in FIG. 3, FIG. 11, and FIG. 12, the twisting component 23 includes a second elastic covering body 232, the second elastic covering body 232 being covered in molding around the periphery of the elastic connecting member 231 and provided with a wiring channel 230, and the wire 211b is disposed in the wiring channel 230.

The second elastic covering body 232 may be partially or wholly covered in the twisting component 23. The second elastic covering body 232 has the ability to deform and can undergo torsion simultaneously with the elastic metal wire. By molding the second elastic covering body 232 around the periphery of the elastic connecting member 231, the tactile sensation of the twisting component 23 can be improved, the exposed length of the wire 211b can be reduced, and the appearance of the twisting component 23 can be beautified.

The wire 211b may be extended to the interior of the speaker component 3 via the twisting component 23, and by providing the wiring channel 230, the twisting component 23 may limit the wire 211b, thereby facilitating the position of the wire 211b inside the speaker to remain stable.

For example, the second elastic covering body 232 is covered around the periphery of the elastic connecting member 231 in a molding manner, such as injection molding or compression molding, etc., and forms the wiring channel 230.

The following is an exemplary structure of the wearing component 2 of the present disclosure.

As shown in FIG. 2, FIG. 11, and FIG. 12, in some embodiments, the wearing component 2 includes the headband component 21 and the twisting component 23, and the headband component 21 includes the clamping component 210. The clamping component 210 is provided in a curved shape along the length direction Lt to allow the headband component 21 to wrap around the periphery of the top of the head of the user in the wearing state and provide a clamping force. The twisting component 23 includes the elastic connecting member 231, and the elastic connecting member 231 includes a first connecting segment 2311 and a second connecting segment 2312 connected with each other. A free end of the first connecting segment 2311 is connected to the clamping component 210, and a free end of the second connecting segment 2312 is connected to the speaker component 3 to position the speaker component 3 at or near the ear of the user in the wearing state in an area of the sound reception area. In some embodiments, starting with the free end of the first connecting segment 2311, the first connecting segment 2311 has an extension component that extends along the sagittal axis SA toward the front side of the face, and the second connecting segment 2312 has an extension component that extends along the vertical axis VA away from the top of the head, the elastic connecting member 231 being itself set to be capable of twisting with the speaker component 3 coming into contact with the head of the user in the wearing state.

The free end of the first connecting segment 2311 is an end of the first connecting segment 2311 away from the second connecting segment 2312, and the free end of the second connecting segment 2312 is an end of the second connecting segment 2312 away from the first connecting segment 2311. Specifically, the clamping component 210 plays a role in supporting and shaping the headband component 21, and by setting the clamping component 210 in a curved shape along the length direction Lt, it can make the shape of the headband component 21 match the contour of the head of the user, so that the user can wear the headband component 21 with greater comfort and stability. During the wearing process of the headband component 21, the clamping component 210 can be deformed under the action of an external force, and a stress can be generated within the clamping component 210, which enables the clamping component 210 to have a clamping effect, thereby improving the wearing stability of the headband component 21.

By providing the elastic connecting member 231 connecting the clamping component 210 and the speaker component 3, the speaker component 3 can be provided with more degrees of freedom of movement, and the speaker component 3 can generate a torsional movement relative to the headband component 21 through the elastic connecting member 231 when the speaker component 3 is positioned in the face area, to improve the wearing comfort of the user, and at the same time, can improve the compatibility of the earphone 1 with the head shape and face shape of the user.

By setting the first connecting segment 2311 to have an extension component that extends along the sagittal axis SA toward the front side of the face, and the second connecting segment 2312 to have an extension component that extends along the vertical axis VA away from the head, on the one hand, this enables the speaker component 3 to be more stably positioned at the ear of the user or the sound reception area near the ear of the user, making the positioning of the speaker component 3 more is stable and the sound output effect is better. On the other hand, the above-described connecting structure has a simple structure, and the first connecting segment 2311 and the second connecting segment 2312 can be twisted in different directions, respectively, thus giving the elastic connecting member 231 more freedom of movement and improving the torsional deformation ability of the elastic connecting member 231, facilitate better adaptation of the speaker component 3 to the head shape and face shape of the user to fit the ear of the user or the sound reception area near the ear of the user, and facilitate simplification of the structure of the elastic connecting member 231.

In some embodiments, the first connecting segment 2311 may be twisted around a sagittal axis SA, causing the speaker component 3 to be twisted around the sagittal axis SA, and the second connecting segment 2312 may be twisted around a vertical axis VA, causing the speaker component 3 is twisted around the vertical axis VA to allow the speaker component 3 to have more degrees of freedom of movement.

In some embodiments, as shown in FIG. 2, FIG. 11, and FIG. 12, the second connecting segment 2312 is connected to the first connecting segment 2311 at an obtuse angle, and in the wearing state, the angle α1 of the second connecting segment 2312 and the vertical axis VA is smaller than the angle α2 between the first connection segment 2311 and the vertical axis VA.

With this configuration, this allows the elastic connecting member 231 to extend along the extension path of the clamping component 210 towards the speaker component 3 to avoid the ear of the user, thereby enhancing the wearing comfort. At the same time, it can make the speaker component 3, along the sagittal axis SA direction, be closer to the front side of the face compared to the headband component 21. When positioning the speaker component 3 to the ear of the user or the sound reception area near the ear, the headband component 21 can also be in the area on the head of the user where the headband component 21 can be stably worn, thereby improving the wearing stability of the wearing component 2 and the positioning effect of the speaker component 3.

The extension direction D22 of the first connecting segment 2311 and the extension direction D21 of the second connecting segment 2312 are different, so that the first connecting segment 2311 and the second connecting segment 2312 can be twisted in different directions, and the elastic connector 231 thereby has more degrees of freedom of movement, enhancing the torsional deformation capacity of the elastic connection member 231 and facilitating the adjustment of the position of the speaker component 3. In some embodiments, the angle α2 between the first connection segment 2311 and the vertical axis VA is larger, which is favorable for the speaker component 3 to rotate around the sagittal axis SA to adjust the position. The angle α1 between the second connecting segment 2312 and the vertical axis VA is smaller, which facilitates the speaker component 3 to rotate around the vertical axis VA to adjust the position.

In some embodiments, as shown in FIG. 2, FIG. 11 and FIG. 12, the wearing component 2 includes the telescoping component 22, the telescoping component 22 includes the fixing portion 221 and the telescoping portion 223, the fixing portion 221 is connected to the end portion of the clamp component 210, and the telescoping portion 223 is telescopically disposed relative to the fixing portion 221, and the free end of the first connecting segment 2311 is connected to an end of the telescoping portion 223 away from the clamping component 210.

The telescoping component 22 is connected between the speaker component 3 and the headband component 21, and the telescoping component 22 may be telescoped under an external force, and the telescoping component 22 may undergo a change in length through telescoping, so that the distance between the speaker component 3 and the headband component 21 may be changed. By setting the telescoping component 22, the structure of the wearing component 2 is more flexible, so that the wearing component 2 can be adapted according to different head shapes and head dimensions when different users are wearing the earphone 1, so that the speaker component 3 is positioned in a suitable position, thereby improving the compatibility of the wearing component 2.

In some embodiments, as shown in FIG. 2, FIG. 11, and FIG. 12, the fixing portion 221 is provided with the sliding groove 2203, and the telescoping portion 223 includes a first telescoping segment 2231 and a second telescoping segment 2232. The first telescoping segment 2231 is slidably disposed within the sliding groove 2203, and the second telescoping segment 2232 is connected to the first telescoping segment 2231 at an obtuse angle. In the wearing state, the angle α3 between the second telescoping segment 2232 and the vertical axis VA is greater than the angle α4 between the first telescoping segment 2231 and the vertical axis VA, and a free end of the first connecting segment 2311 is connected to a free end of the second telescoping segment 2232.

By setting the second telescoping segment 2232 to be connected to the first telescoping segment 2231 at an obtuse angle, the telescoping portion 223 can have a streamlined structure. The transition between the second telescoping segment 2232 and the first telescoping segment 2231 is natural, which can enhance the aesthetic appeal of the overall structure.

The telescoping portion 223 is movable relative to the fixing portion 221 in the direction of extension of the sliding groove 2203. The extension direction D24 of the first telescoping segment 2231 may be consistent with the extension direction of the sliding groove 2203 to allow the telescoping portion 223 to slide along the extension direction of the sliding groove 2203. The extension direction D23 of the second telescoping segment 2232 may be close to or consistent with the extension direction D22 of the first connecting segment 2311 to allow the free end of the first connecting segment 2311 to align with the free end of the second telescoping segment 2232 for connection.

By setting the angle α3 of the second telescoping segment 2232 with the vertical axis VA to be greater than the angle α4 of the first telescoping segment 2231 with the vertical axis VA, it results in the first telescoping segment 2231 having a smaller angle α4 with the vertical axis VA and the second telescoping segment 2232 having a larger angle a3 with the vertical axis VA. Because the angle α4 of the first telescoping segment 2231 with the vertical axis VA is smaller, the speaker component 3 may be displaced more along the direction of the vertical axis VA when the telescoping portion 223 is sliding with respect to the fixing portion 221, thereby enabling greater compatibility with the head shape and face shape of the user. Because the angle α3 of the second telescoping segment 2232 with the vertical axis VA is larger, the second telescoping segment 2232 may generate an extension component along the direction of the sagittal axis SA, thereby facilitating positioning the speaker component 3 at the ear of the user or the sound reception area near the ear. Specifically, the speaker component 3 is closer to the front side of the face along the direction of the sagittal axis SA as compared to the headband component 21, and the angle α3 of the second telescoping segment 2232 with the vertical axis VA may enable the second telescoping segment 2232 to have an extension component along the direction of the sagittal axis SA, which facilitates the realization of the connection between the speaker component 3 and the headband component 21 along the sagittal axis SA.

In some embodiments, the angle α2 between the first connecting segment 2311 and the vertical axis VA is larger, while the angle between the fixing portion 221 and the vertical axis VA is smaller, and by setting the angle α3 between the second telescoping segment 2232 and the vertical axis VA to be larger than the angle between the first telescoping segment 2231 and the vertical axis VA, it is possible to facilitate assembly and connection between the telescoping portion 223 and the fixing portion 221 and the elastic connecting member 231.

In some embodiments, as shown in FIG. 4, FIG. 11, and FIG. 12, the headband component 21 further includes the wire 211b and the first elastic covering body 212, and the first elastic covering body 212 includes the covering body 2121. The covering body 2121 is molded to cover around the periphery of the wire 211b and the clamping component 210, two ends of the wire 211b extending from the covering body 2121. The wire 211b extends from the exterior of the telescoping component 22 to the twisting component 23 and is secured to the twisting component 23. The length of the wire 211b on the exterior of the telescoping component 22 is greater than the maximum elongation of the telescoping component 22. The wire 211b illustrated in FIG. 11 and FIG. 12 illustrates only one segment, and does not limit the shape and length of the wire 211b.

The telescoping component 22 is attached to each end of the headband component 21. The covering body 2121 can limit and protect the wire 211b, and guide the wire 211b to extend from the outside of one telescoping component 22 to the outside of another telescoping component 22. As compared to setting the wire 211b inside the telescoping component 22, setting the wire 211b outside the telescoping component 22 can avoid the telescoping component 22 interfering with the wire 211b during telescoping, at the same time, it also helps to reduce the dimension of the telescoping component 22 to improve the aesthetics.

The twisting component 23 guides the wire 211b into the inside of the speaker component 3. By securing the wire 211b to the twisting component 23, the twisting component 23 may limit the wire 211b, thereby facilitating the position of the wire 211b inside the speaker to remain stable. For example, interference with the position of the wire 211b inside the speaker component 3 by the telescoping process of the telescoping component 22 may be reduced.

In some embodiments, as shown in FIG. 11 and FIG. 12, the twisting component 23 further includes a first splice portion 233 and a second splice portion 234 disposed at the two ends of the elastic connecting member 231, the first splice portion 233 is mated with the speaker component 3, and the second splice portion 234 fits with the free end of the second telescoping segment 2232.

The first splice portion 233 and the second splice portion 234 may position both ends of the elastic connecting member 231. By providing the first splice portion 233 and the second splice portion 234, the component structure can be simplified, and it is easy to carry out the assembly and connection of the elastic connecting member 231 and the speaker component 3 and the telescoping component 22, and improve the assembly efficiency. Furthermore, the second splice portion 234 is inserted into the interior of the free end of the second telescoping segment 2232 and secured to the free end of the second telescoping segment 2232 through a pin or a threaded fastener 226.

In some embodiments, as shown in FIG. 11 and FIG. 12, the speaker component 3 includes the main shell 31, the main shell 31 is provided with the splice hole 310, the second elastic covering body 232 and the first splice portion 233 are inserted into the splice hole 310, and an outlet of the wiring channel 230 is disposed in the splice hole 310.

By inserting the second elastic covering body 232 and the first splice portion 233 into the splice hole 310, the main shell 31 can obscure the end portion of the second elastic covering body 232 and the end portion of the first splice portion 233, thereby enhancing the aesthetics of the wearing component 2. By placing the outlet of the wiring channel 230 within the splice hole 310, the wire 211b can be shielded to improve aesthetics on the one hand, and on the other hand, it is easy to introduce the wire 211b into the speaker for connection during assembly.

In some embodiments, as shown in FIG. 2, FIG. 11, and FIG. 12, the end portion of the second elastic covering body 232 is provided with a flange portion 2321, and the splice hole 310 includes a first hole section 3101 and a second hole section 3102 that are connected to each other. The second hole section 3102 is closer to the interior of the main shell 31 compared to the first hole section 3101, and the hole diameter of the first hole section 3101 is larger than the hole diameter of the second hole section 3102. The flange portion 2321 is inserted within the first hole section 3101, and a cross-section perpendicular to the direction of insertion matches the cross-section of the first hole section 3101, and the first splice portion 233 protrudes from an end face of the flange portion 2321 and is inserted within the second hole section 3102, and the outlet of the wiring channel 230 is located at an end face of the flange portion 2321.

The flange portion 2321 enhances the structural strength of the end portion of the second elastic covering body 232, and the insertion of the flange portion 2321 into the first hole section 3101 restricts relative displacement of the end portion of the twisting component 23 relative to the speaker component 3 in a direction perpendicular to the insertion direction.

By protruding the first splice portion 233 from the end surface of the flange portion 2321 and inserting it into the second hole section 3102, it is convenient to fix the first splice portion 233 to the main shell 31 to limit the twisting component 23 from disengaging from the main shell 31, to improve the stability of the connection structure of the end portion of the twisting component 23 and the speaker component 3.

In some embodiments, as shown in FIG. 11 and FIG. 12, the main shell 31 may be provided with a U-shaped insert 3103, which is inserted into the interior of the first splice portion 233 through the hole wall of the second hole section 3102 to secure the first splice portion 233 on the main shell 31.

In some embodiments, as shown in FIG. 4 and FIG. 11, the telescoping component 22 further includes a retaining portion 225 that remains relatively fixed to the fixing portion 221, and the wire 211b on the exterior of the telescoping component 22 is retained on the retaining portion 225.

By providing the retaining portion 225, the wire 211b can be restricted from interfering with other portions of the wearing component 2, and the aesthetics can be improved.

For example, the retaining portion 225 is a clip or buckle. As another example, the retaining portion 225 is provided with a hole, and the wire 211b is threaded through the hole and thus retained on the retaining portion 225.

In some embodiments, the wire 211b is provided to move relative to the retaining portion 225 as the telescoping portion 223 telescopes.

With this configuration, the wire 211b can be made to move away from the speaker component 3 within the retaining portion 225 during contraction of the telescoping component 22, and the wire 211b can be made to move toward the speaker component 3 within the retaining portion 225 during extension of the telescoping component 22, thereby avoiding pulling on the wire 211b during telescoping, reducing the force on the wire 211b, and improving the service life of the wire 211b.

The following is an exemplary structure of the stick microphone component 7, etc., of an embodiment of the earphone of the present disclosure.

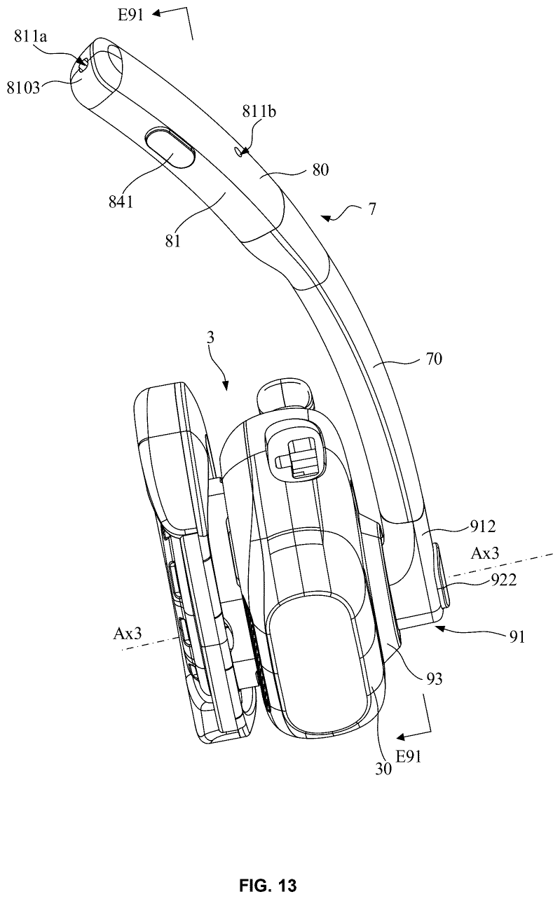

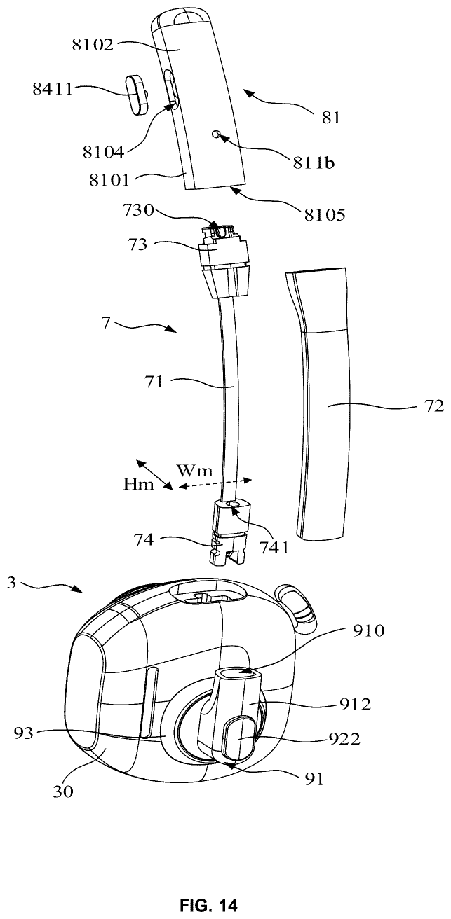

As shown in FIG. 1, FIG. 13, and FIG. 14, in some embodiments, the earphone 1 may include the wearing component 2, the speaker component 3, and the stick microphone component 7. The wearing component 2 is connected to the speaker component 3, and the stick microphone component 7 is rotatably disposed on the speaker component 3 around the preset axis Ax3. The stick microphone component 7 includes the stick assembly 70 and the microphone assembly 80. The microphone assembly 80 is fixedly connected to the stick assembly 70. The stick assembly 70 is configured to position the microphone assembly 80 in a sound pickup region corresponding to the mouth of the user when the earphone 1 is in the wearing state. The stick assembly 70 includes an elastic sheet 71 and an elastic covering body 72, the elastic covering body 72 covering the elastic sheet 71, the elastic sheet 71 having the thickness direction Hm and the width direction Wm perpendicular to each other, and the elastic sheet 71 having a dimension in the thickness direction Hm that is smaller than its dimension in the width direction Wm. The thickness direction Hm is set toward or away from the face in the wearing state.

The speaker component 3 delivers sound to the human ear. The wearing component 2 may position the speaker component 3 next to the ear of the user, and the wearing component 2 may also give the speaker component 3 a force to make the speaker component 3 fit on the face area next to the ear of the user. Specifically, the wearing component 2 is configured to wrap around the top of the head of the user and may cause the speaker component 3 to be positioned overall on the front side of the ear of the user. The shape of the wearing component 2 can be matched to the contour of the head of the user, which makes it more comfortable and stable for the user to wear the earphone 1.

The microphone assembly 80 may capture the sound emitted from the user's mouth to capture the voice of the user. The stick assembly 70 may be coupled between the microphone assembly 80 and the speaker component 3, and by controlling the movement of the stick assembly 70, the microphone assembly 80 may be controlled to be in different positions and postures. For example, at the end of use of the microphone assembly 80, the microphone assembly 80 can be driven away from the sound pickup area and closer to the wearing component 2 by controlling the movement of the stick assembly 70, causing the microphone assembly 80 to be in a stowed position.

The elastic covering body 72 can enhance the tactile sensation when the user comes into contact with the earphone 1, and improve the wearing comfort of the earphone 1. For example, the elastic covering body 72 covers the elastic sheet 71 by injection molding or compression molding, etc.

When the elastic sheet 71 is deformed under external force during use of the microphone assembly 80, the elastic covering body 72 has a deformation capability and can be deformed in synchronization with the elastic sheet 71, so as to make the structure of the stick assembly 70 more flexible. The shape and position of the stick assembly 70 can be adjusted according to the head shape of the user when the earphone 1 is worn by different users to be able to locate the microphone assembly 80 in a suitable position. Setting up in this way allows the microphone assembly 80 to have more freedom of movement to capture sound in a more reasonable manner, which improves the compatibility of the earphone 1, while enhancing the wearing comfort of the user.

By setting the dimension of the elastic sheet 71 in the thickness direction Hm to be smaller than the dimension in the width direction Wm, and by setting the thickness direction Hm toward or away from the human face in the wearing state, the smaller dimension HD1 of the elastic sheet 71 along the thickness direction Hm can make the elastic sheet 71 tend to deform along the thickness direction Hm when it deforms, so that it is easy to adjust the distance between the stick microphone component 7 and the human face and mouth to satisfy different needs for capturing sound, and the larger dimension WD1 along the width direction Wm can make the elastic sheet 71 not easy to deform in the width direction Wm, so that the elastic sheet 71 can realize a more stable directional elastic deformation in the thickness direction Hm, and at the same time, the elastic sheet 71 can maintain sufficient ability to support and maintain shape, improving the positioning stability of the microphone assembly 80.

In some embodiments, as shown in FIG. 13 and FIG. 14, the stick assembly 70 is rotatable about the preset axis Ax3 with respect to the speaker component 3. The elastic sheet 71 includes two side edges disposed back-to-back in the width direction Wm, and the elastic sheet 71 is provided such that when rotating in a rotation direction about the preset axis Ax3, one of the side edges is disposed ahead of the rotation direction and the other edge is disposed behind the rotation direction.

By setting the stick assembly 70 to be able to rotate around the preset axis Ax3 relative to the speaker component 3, due to the large dimension in the width direction Wm, one edge is located in the front, while the other edge is located in the back. When the stick assembly 70 is moved in the width direction Wm, it is less likely to undergo elastic deformation, allowing the microphone assembly 80 to rotate around the preset axis Ax3 in a directional manner. This enables it to have a larger range of movement, thus meeting different sound capture requirements. The stick assembly 70, by rotating about the preset axis Ax3 with respect to the speaker component 3, also allows the microphone assembly 80 to switch between a stowed position and a working position.

Additionally, by setting the elastic sheet 71 such that, when rotating in the rotation direction about the preset axis Ax3, one edge of both edges is located in front of the rotation direction and the other edge is located in the rear of the rotation direction, it is possible to make the rotation direction of the elastic sheet 71 inconsistent with the deformation direction to further expand the freedom of movement and the range of activity of the microphone assembly 80 to meet the needs for more sound capture.

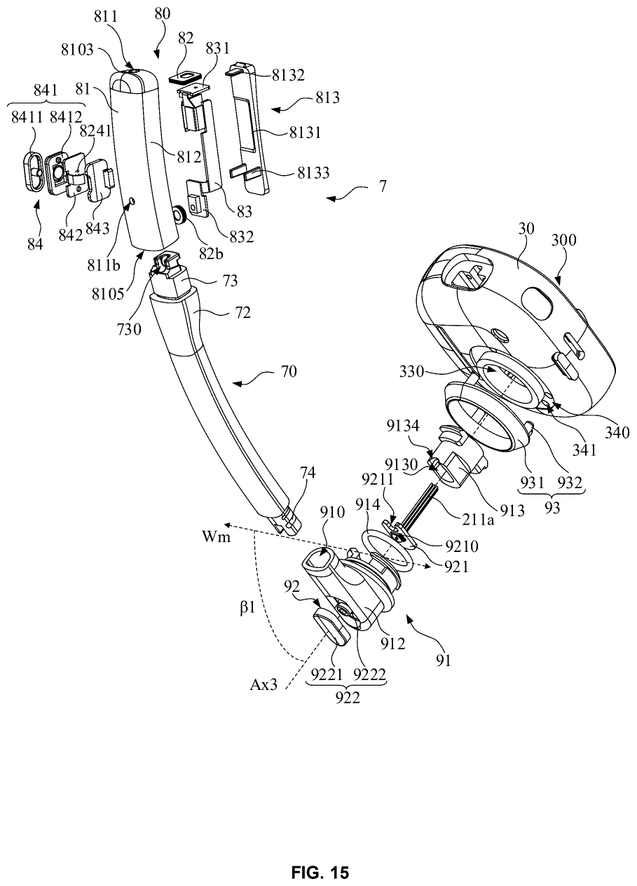

In some embodiments, as shown in FIG. 15, the angle β1 between the width direction Wm and the preset axis Ax3 is ≥80°, and ≤90°. For example, the angle β1 between the width direction Wm and the preset axis Ax3 is 82°, 84°, 85°, or 87°.

With this configuration, the rotation direction of the elastic sheet 71 can be made to differ from the direction of deformation, which in turn allows the microphone assembly 80 to have a greater range of movement, and the microphone assembly 80 can have a greater number of postures to meet the needs for capturing more sounds. If the angle 31 between the width direction Wm and the preset axis Ax3 is less than 80°, the rotation direction of the elastic sheet 71 is closer to the deformation direction, which in turn restricts the movable range of the microphone assembly 80.

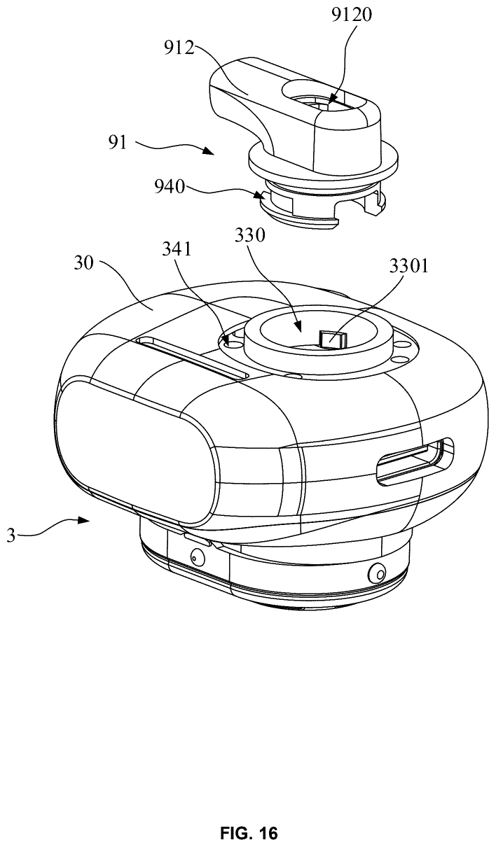

In some embodiments, as shown in FIG. 13 and FIG. 16, the stick assembly 70 has a rotation angle in the rotation direction about the preset axis Ax3 in the range of 0 to 135°. For example, the stick assembly 70 has an angle of rotation in the rotation direction such as 30°, 60°, 90°, or 120°.

Set up in such a manner, it is favorable for the microphone assembly 80 to be active in an area where the sound is effectively captured to improve the effect of the microphone assembly 80 in capturing the voice, and at the same time, it is convenient to adjust the position of the microphone assembly 80, reducing the probability of adjusting the microphone assembly 80 to an unreasonable position. If the range of this rotation angle is larger, it will lead to an increased probability of adjusting the microphone assembly 80 to an unreasonable position, which is not conducive to the microphone assembly 80 performing its work, and reduces the effect of the user experience.

In some embodiments, as shown in FIG. 13 and FIG. 16, the stick assembly 70 is provided with a limit groove 940, the limit groove 940 extends along the rotation direction of the stick assembly 70, and the speaker component 3 is provided with a limit protrusion 3301, the limit protrusion 3301 is slidably inserted into the limit groove 940. Two ends of the limit groove 940 are used to restrict the limit protrusion 3301 from sliding, and thus to limit the relative rotation of the stick assembly 70 and the speaker component 3.

In some embodiments, as shown in FIG. 1, FIG. 13, and FIG. 14, one end of the stick assembly 70 is connected to the speaker component 3, and the other end is connected to the microphone assembly 80. In the natural state, the elastic sheet 71 is gradually bent in a direction toward a human face from an end close to the speaker component 3 to an end away from the speaker component 3.

The direction of extension of the stick assembly 70 may be close to or consistent with the direction of extension of the elastic sheet 71. By setting the elastic sheet 71 to gradually bend in a direction toward the human face from one end of the elastic sheet 71 close to the speaker component 3 to one end of the elastic sheet 71 away from the speaker component 3, it is possible to bring the microphone assembly 80 close to the sound pickup region, to facilitate capturing the sound of the human mouth and improve the sound pickup effect, and at the same time reduce the risk of interference between the stick assembly 70 and the human face and improve the wearing comfort.

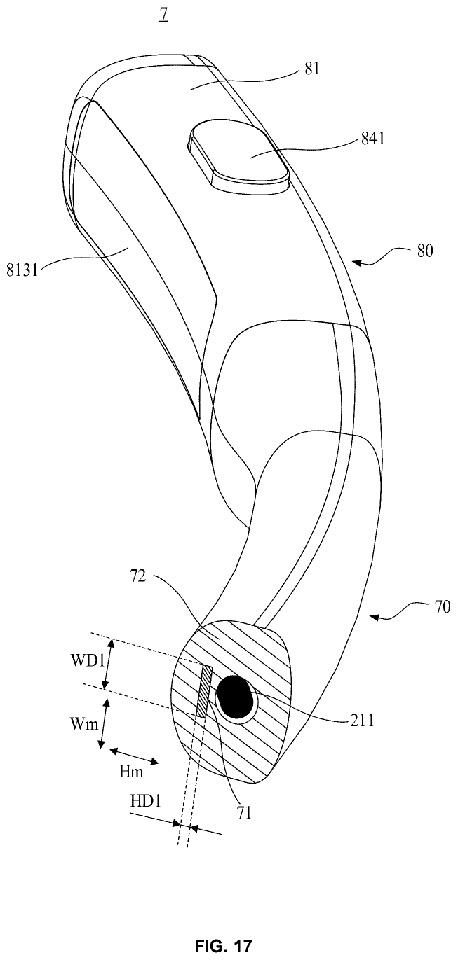

In some embodiments, as shown in FIG. 14 and FIG. 17, the ratio of the dimension HD1 of the elastic sheet 71 along the thickness direction Hm and the dimension WD1 along the width direction Wm is 0.1˜0.3. For example, the ratio of the dimension HD1 of the elastic sheet 71 along the thickness direction Hm and the dimension WD1 along the width direction Wm is 0.12, 0.15, 0.2, or 0.25.

Such a setting allows the elastic sheet 71 to be easily deformed in the thickness direction Hm and not easily deformed in the width direction Wm, which facilitates adjustment of the position of the microphone assembly 80. If the ratio is too large, the elastic sheet 71 is not easy to be deformed in the thickness direction Hm, which increases the degree of difficulty of the user in adjusting the position of the microphone assembly 80; if the ratio is too small, the elastic sheet 71 has a poor mechanical strength and provides insufficient support and shaping effect, which will adversely affect the structural stability of the stick assembly 70.

In some embodiments, the elastic sheet 71 is a titanium sheet. This can make the elastic sheet 71 have good mechanical strength and deformation capacity, which is conducive to improving the service life of the elastic sheet 71.

In some embodiments, the dimension HD1 of the elastic sheet 71 along the thickness direction Hm ranges from 0.3 to 0.5 mm. Furthermore, the dimension HD1 of the elastic sheet 71 along the thickness direction Hm ranges from 0.36 to 0.44 mm.

With this configuration, it can make the elastic sheet 71 easy to be deformed in the thickness direction Hm, so that it is easy to adjust the position of the microphone assembly 80, and the elastic sheet 71 can also have sufficient mechanical strength, to have a good support and shaping function. If the dimension is too large, the elastic sheet 71 is not easy to be deformed in the thickness direction Hm, which increases the degree of difficulty of the user in adjusting the position of the microphone assembly 80; if the dimension is too small, the elastic sheet 71 has a poor mechanical strength, and the support and shaping function is not sufficient.

In some embodiments, the dimension WD1 of the elastic sheet 71 along the width direction Wm ranges from 1.8 to 2.2 mm. Furthermore, the dimension WD1 of the elastic sheet 71 along the width direction Wm ranges from 1.96 to 2.04 mm.

With this configuration, it can make the elastic sheet 71 not easy to be deformed in the width direction Wm, to facilitate the user in directional adjusting of the position of the microphone assembly 80, and the elastic sheet 71 can also have sufficient mechanical strength, to have a good supportive shaping function. If the dimension is too large, the elastic sheet 71 will occupy a large space, which is not conducive to the miniaturization of the stick assembly 70; if the dimension is too small, the elastic sheet 71 will have a poor mechanical strength, which will provide insufficient support and the shaping function, and at the same time influence the directional deformation of the elastic sheet 71.

In some embodiments, as shown in FIG. 1 and FIG. 13, the microphone assembly 80 is fixedly coupled to the end of the stick assembly 70 away from the preset axis Ax3. When the microphone assembly 80 is in operation, the end of the stick assembly 70 proximate to the preset axis Ax3 is near the ear of the user, and the end of the stick assembly 70 away from the preset axis Ax3 is near the mouth of the user, so that the earphone 1 can extend from beside the ear of the user to beside the mouth of the user.

The microphone assembly 80 includes a housing 81, a microphone 82, a microphone circuit board 83, and a button module 84. The housing 81 is provided with an accommodating cavity 810 and a microphone hole 811 connected to the accommodating cavity 810. The microphone 82 and the microphone circuit board 83 are provided in the accommodating cavity 810, and the microphone 82 is fixed to the microphone circuit board 83 and is provided opposite to the microphone hole 811. The housing 81 includes two first shell walls 8101 disposed back-to-back along the width direction Wm, two second shell walls 8102 disposed back-to-back along the thickness direction Hm, and an end wall 8103 at an end remote from the preset axis Ax3. The microphone hole 811 is provided in the second shell walls 8102 or the end wall 8103, and the button module 84 is provided on the first shell walls 8101, and the button module 84 is configured to control the microphone 82 to be turned on or off.

External sound may be transmitted to the microphone 82 through the microphone hole 811, and the microphone 82 may convert the captured sound into an electrical signal, and the microphone circuit board 83 may be provided with circuits that cooperate with the microphone 82.

By setting the microphone hole 811 on the second shell walls 8102 or the end wall 8103, and the button module 84 on the first shell walls 8101, the button module 84 and the microphone hole 811 can be made to be on different surfaces of the housing 81, respectively. There is a large distance between the button module 84 and the microphone hole 811, which can reduce the occurrence of blocking the microphone hole 811 when the user presses the button module 84, and can also reduce the adverse effect of the generated mechanical noise of the button on the reception of the microphone 82, and improve the effect of the microphone assembly 80 in capturing sound, so that it is easy for the user to press the button module 84.

In some embodiments, the microphone circuit board 83 may be a flexible printed circuit board (FPC).

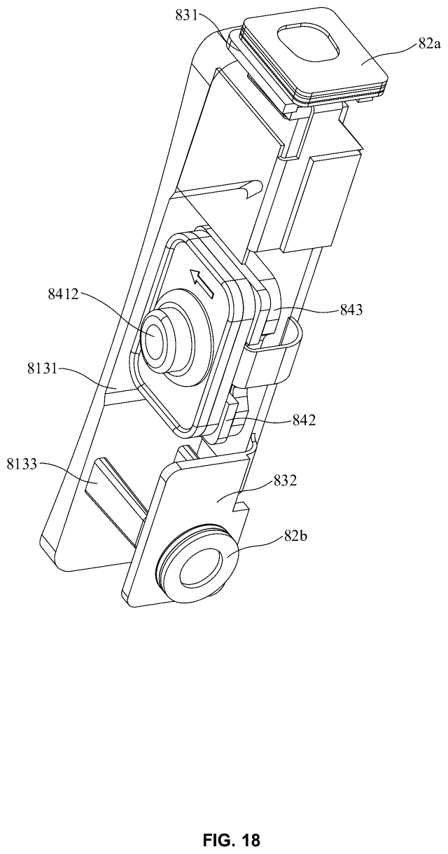

In some embodiments, as shown in FIG. 14, FIG. 15, and FIG. 18, the first shell wall 8101 is provided with a button hole 8104, and the button module 84 includes a button 841 and an adapter circuit board 842, and the adapter circuit board 842 is electrically connected to the microphone circuit board 83. The adapter circuit board 842 is disposed in the accommodating cavity 810, the button 841 is disposed through the button hole 8104 and blocks the button hole 8104, the adapter circuit board 842 is disposed with a switch 8421, and the button 841 abuts against the switch 8421. The microphone 82 can be turned on or off by pressing the switch 8421.

The adapter circuit board 842 and the button 841 can effectively realize the function of controlling the microphone 82 to be turned on or turned off, thus adapting to the structural configuration of the earphone 1 without the need to set up the switch 8421 on the microphone circuit board 83. As compared to setting the circuits on the microphone circuit board 83 and the adapter circuit board 842 onto a single circuit board, separately setting the microphone circuit board 83 and the adapter circuit board 842 can reduce crosstalk between the circuitry on the microphone circuit board 83 and the circuitry on the adapter circuit board 842. Sealing the button hole 8104 by setting the button 841 is conducive to reducing the entry of water vapor and dust from outside into the accommodating cavity 810 and improving the sealing effect.

In some embodiments, the adapter circuit board 842 is a flexible printed circuit board (FPC).

In some embodiments, as shown in FIG. 14, FIG. 15, and FIG. 18, the button 841 includes an elastic body 8412 and a button body 8411 that resists the elastic body 8412, and the elastic body 8412 is disposed within the accommodating cavity 810 and blocks the button hole 8104 from within the accommodating cavity 810, and the button body 8411 is disposed on a side of the elastic body 8412 that is away from the accommodating cavity 810 and is exposed through the button hole 8104. The button module 84 includes a fixing plate 843, the fixing plate 843 being supported on the side of the adapter circuit board 842 away from the elastic body 8412 to sandwich the adapter circuit board 842 between the fixing plate 843 and the elastic body 8412, and the fixing plate 843 is fixedly disposed within the accommodating cavity 810.

The elastic body 8412 is elastically deformable, so that when the button body 8411 is pressed, a force can be exerted by the elastic body 8412 on the adapter circuit board 842 to trigger the switch 8421. The fixing plate 843 facilitates the installation of the adapter circuit board 842, which makes the structure of the button module 84 more firm and stable after the adapter circuit board 842 is installed.

In some embodiments, the elastic body 8412 is compressed and tightly pressed against the housing 81 to seal the button hole 8104. In other embodiments, the elastic body 8412 is sealingly connected to the housing 81 by molding, such as injection molding or compression molding, etc.

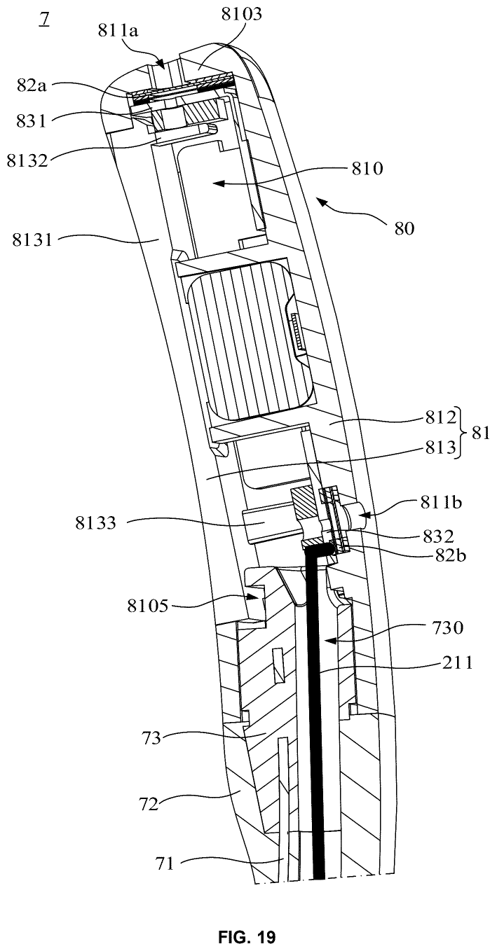

In some embodiments, as shown in FIG. 14, FIG. 15, and FIG. 19, at least two microphones 82 may be provided, including a first microphone 82a and a second microphone 82b, respectively, and at least two microphone holes 811 may be provided, respectively including a first microphone hole 811a and a second microphone hole 811b, the first microphone hole 811a being disposed at the end wall 8103, and the second microphone hole 811b being disposed at the second shell wall 8102. The first microphone 82a and the second microphone 82b are fixedly disposed on the microphone circuit board 83 and correspond to the first microphone hole 811a and the second microphone hole 811b, respectively. The second microphone hole 811b is located between two ends of the housing 81, closer to the end of the housing 81 near the preset axis Ax3.

Specifically, the first microphone hole 811a and the second microphone hole 811b have different outward orientations. The second microphone hole 811b is farther away from the mouth and captures stronger ambient noise. The first microphone hole 811a is closer to the mouth and captures stronger user voices, so that the effect of eliminating the ambient noise can be realized by the first microphone hole 811a and the second microphone hole 811b. Furthermore, the second microphone hole 811b is disposed on the second shell wall 8102 that is away from the human face to enhance the capture of ambient noise.

In addition, the provision of at least two microphones 82 enhances the effect of picking up the sound, and the at least two microphones 82 are farther away from each other, which facilitates the picking up of sound from a larger range and also reduces the mutual interference between them. Additionally, the two microphones 82 are farther apart, and the two microphones 82 are less likely to be obscured by the user simultaneously when the button module 84 is pressed.

In some embodiments, as shown in FIG. 14, FIG. 15, and FIG. 19, the housing 81 includes a shell 812 and a cover 813. The shell 812 has a portion of the second shell wall 8102, which forms an opening that connects with the accommodating cavity 810. The cover 813 caps the opening to form another corresponding portion of the second shell wall 8102. Set up in this manner, it is easy to carry out the assembly of the various parts of the interior of the housing 81.

The microphone circuit board 83 includes a first fixing plate portion 831 and a second fixing plate portion 832. The first fixing plate portion 831 is provided opposite the end wall 8103 for fixing the first microphone 82a. The second fixing plate portion 832 is provided opposite a corresponding second shell wall 8102 for fixing the second microphone 82b. Such a setting facilitates the mounting of the microphone 82, making the electrical connection between the microphone 82 and the microphone circuit board 83 more solid and stable after the microphone 82 is mounted. At the same time, it is conducive to keeping the position of the microphone 82 stable, and it also makes the microphone circuit board 83 structurally flexible, which is conducive to the miniaturization of the stick assembly 70.

The cover 813 includes a cover plate 8131, a first support protrusion 8132, and a second support protrusion 8133, the first support protrusion 8132 and the second support protrusion 8133 project from a side of the cover plate 8131 toward the accommodating cavity 810. The first support protrusion 8132 is provided opposite the end wall 8103 to support the first fixing plate portion 831 and/or the first microphone 82a toward the end wall 8103. The second support protrusion 8133 extends toward the corresponding second shell wall 8102 to support the second fixing plate portion 832 and/or the second microphone 82b.

Specifically, the first support protrusion 8132 and the second support protrusion 8133 extend in the same direction, with a side of the first support protrusion 8132 supporting the first fixing plate portion 831, and an end surface of the second support protrusion 8133 along its extension direction supporting the second fixing plate portion 832. Such a setting facilitates installation of the microphone 82 and the microphone circuit board 83, and makes the internal structure of the housing 81 more solid and stable after the microphone 82 and the microphone circuit board 83 are installed. In some embodiments, the number of second support protrusions 8133 is two or more to improve the limiting effect on the second fixing plate portion 832.

In some embodiments, as shown in FIG. 13 to FIG. 15, FIG. 19, the stick assembly 70 includes the first splice block 73 fixedly disposed at an end of the elastic sheet 71 away from the preset axis Ax3, and the elastic covering body 72 further extends and covers a portion of a periphery of the first splice block 73. The first splice block 73 is provided with a first lead hole 730. The end of the housing 81 near the preset axis Ax3 is provided with a first splice hole 8105, the first splice block 73 is inserted into the first splice hole 8105, and the microphone circuit board 83 is connected with a wire 211, and the wire 211 is threaded from the accommodating cavity 810 through the first lead hole 730 into the elastic covering body 72 to be led to the speaker component 3.

With this configuration, it facilitates the assembly and connection between the stick assembly 70 and the microphone assembly 80.

The first splice hole 8105 may be connected to the accommodating cavity 810. By providing the first lead hole 730 on the first splice block 73, the wire 211 can be secured and protected, and it is easy to thread the wire 211 from the accommodating cavity 810 into the elastic covering body 72. By threading the wire 211 into the elastic covering body 72, the elastic covering body 72 protects the wire 211, and the wire 211 can move with respect to the elastic covering body 72 and the first splice block 73, thereby reducing the pulling on the wire 211 during deformation of the elastic sheet 71, which is conducive to improving the service life of the wire 211.

A portion of the periphery of the first splice block 73 that is not encompassed by the elastic covering body 72 may be inserted into the first splice hole 8105. Furthermore, a periphery of the elastic covering body 72 is flush with a periphery of the housing 81 at their connection point to improve aesthetic appearance.

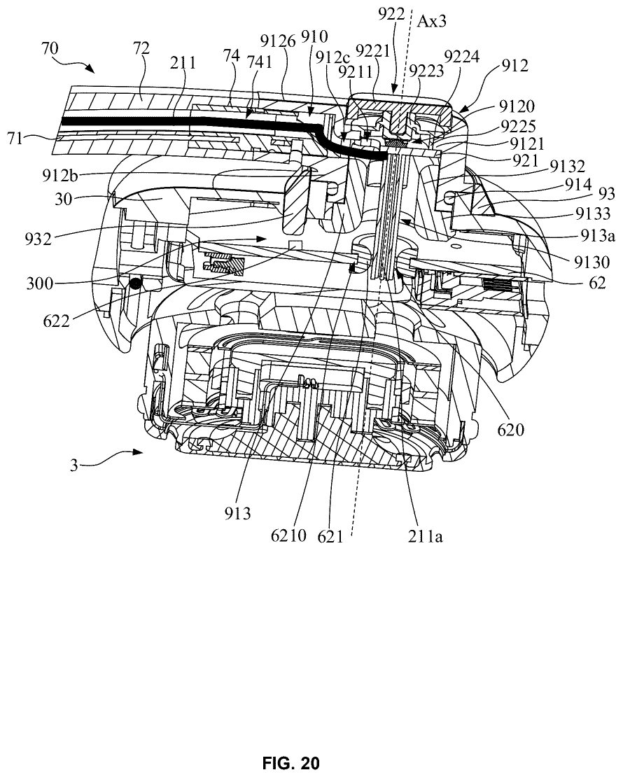

In some embodiments, as shown in FIG. 13 to FIG. 15, and FIG. 20, the stick microphone component 7 includes a pivot mechanism 91. The stick assembly 70 includes a second splice block 74 fixedly disposed at an end of the elastic sheet 71 near the preset axis Ax3, and the elastic covering body 72 further extends to cover around a portion of a periphery of the second splice block 74. The pivot mechanism 91 is rotatably disposed about the preset axis Ax3 on the speaker component 3. The pivot mechanism 91 is provided with the second splice hole 910, and the second splice block 74 is inserted in the second splice hole 910. The second splice block 74 is provided with a second lead hole 741, and the wire 211 of the stick microphone component 7 is introduced into the pivot mechanism 91 from inside the elastic covering body 72 through the second lead hole 741, and enters into the speaker component 3 through the pivot mechanism 91.

With this configuration, it is easy to carry out the assembly and connection between the stick assembly 70 and the pivot mechanism 91.

By rotatably disposing the pivot mechanism 91 on the speaker component 3 about the preset axis Ax3, it is possible to enable the stick assembly 70 and the microphone assembly 80 to rotate about the preset axis Ax3.

The second splice hole 910 may be internally connected to the pivot mechanism 91. By providing the second lead hole 741 on the second splice block 74, the wire 211 can be secured and protected, facilitating the threading of the wire 211 from within the elastic covering body 72 into the pivot mechanism 91. The wire 211 is movable with respect to the elastic covering body 72 and the second splice block 74, so that the pulling of the wire 211 can be reduced when the elastic sheet 71 is deformed, which is conducive to improving the service life of the wire 211.

A portion of a periphery of the second splice block 74 that is not encompassed by the elastic covering body 72 may be inserted into the second splice hole 910. Furthermore, the periphery of the elastic covering body 72 is flush with the periphery of the pivot mechanism 91 at their connection point to improve aesthetic appearance.

The following is an exemplary structure of the stick microphone component 7, etc., of an embodiment of the earphone of the present disclosure.

As shown in FIG. 1, FIG. 13, and FIG. 15, in some embodiments, the earphone 1 may include the wearing component 2, the speaker component 3, and the stick microphone component 7. The wearing component 2 is connected to the speaker component 3, and the stick microphone component 7 is rotatably disposed on the speaker component 3 around a preset axis Ax3. The speaker component 3 includes the shell assembly 30 and a speaker, the shell assembly 30 being provided with an accommodation space 300 and a pivot hole 330 connected to the accommodation space 300, and the speaker being provided in the accommodation space 300. The stick microphone component 7 includes a button module 92, the stick assembly 70, and the pivot mechanism 91. The pivot mechanism 91 is disposed through the pivot hole 330 and is rotatable about the preset axis Ax3 relative to the shell assembly 30. The pivot mechanism 91 includes a pivot base 912 and a pivot bracket 913, the pivot base 912 and the pivot bracket 913 being assembled along the preset axis Ax3. A portion of the pivot base 912 is disposed outside the shell assembly 30 and is connected to the stick assembly 70. The button module 92 includes a button circuit board 921 and a button 922. The button circuit board 921 is sandwiched between the pivot base 912 and the pivot bracket 913. The button circuit board 921 is provided with a switch 9210, and the button 922 is provided on the pivot base 912 for pressing the switch 9210.

The speaker may include at least one of a bone conduction speaker 40 and an air conduction speaker 50.

The speaker component 3 may transmit sound to the human ear. The wearing component 2 may position the speaker component 3 next to the ear of the user, and the wearing component 2 may also apply a force to the speaker component 3 to cause the speaker component 3 to fit against a face area next to the ear of the user. The stick microphone component 7 may capture a sound emitted from the human mouth to capture the voice of the user.

By installing the pivot mechanism 91, it is convenient to assemble and connect the stick assembly 70 and the speaker component 3, and by setting the pivot mechanism 91 to rotate about the preset axis Ax3 relative to the shell assembly 30, the stick microphone component 7 can be enabled to rotate about the preset axis Ax3, so that the stick microphone component 7 has a greater range of motion to meet different needs for capturing sound. In addition, the stick microphone component 7 can be switched between a stowed position and a working position by rotating about the preset axis Ax3.

The button module 92 can be used to trigger the stick microphone component 7 to work. For example, a user may answer a phone call by pressing the button module 92, and the stick microphone component 7 picks up the voice of the user when the user speaks.

Specifically, the button 922 may be disposed on a portion of the pivot base 912 disposed outside of the shell assembly 30 and exposed externally for pressing. A portion of the pivot bracket 913 may be disposed within the shell assembly 30 for restricting the pivot bracket 913 from detaching from the shell assembly 30.

By setting the button circuit board 921 to be sandwiched between the pivot base 912 and the pivot bracket 913, it is possible to cause the button circuit board 921 to remain fixed to the pivot mechanism 91, and when the pivot mechanism 91 is rotated, the button circuit board 921 rotates in synchronization with the pivot mechanism, and the button circuit board 921 can be assembled and fixed during the assembly process of the pivot base 912 and the pivot bracket 913, which facilitates the installation of the button circuit board 921 and improves the assembly efficiency.

In some embodiments, the pivot base 912 is provided to be assembled on the shell assembly 30 from the exterior of the shell assembly 30 and partially disposed within the pivot hole 330. Set up in this manner, it may be convenient to carry out the assembly of the pivot base 912 on the shell assembly 30, and at the same time, it may be convenient to carry out the assembly and connection of the pivot base 912 to the stick assembly 70. The pivot bracket 913 is provided to be assembled with the pivot base 912 from within the accommodation space 300 such that the pivot base 912 is retained in the pivot hole 330. Set up in this manner, it may be convenient to confine the pivot bracket 913 at least partially to the interior of the shell assembly 30, which in turn facilitates assembling the pivot base 912 on the shell assembly 30 by the pivot bracket 913, and restricts the pivot base 912 from detaching from the shell assembly 30. During the assembly of the pivot base 912 and the pivot bracket 913, the assembly of the button circuit board 921 may be carried out at the same time to improve the assembly efficiency.

In some embodiments, as shown in FIG. 13 and FIG. 16, the pivot base 912 is provided with the limit groove 940, the limit groove 940 extends along a rotation direction of the pivot base 912, and the pivot hole 330 is provided with the limit protrusion 3301. The limit protrusion 3301 is slidably inserted into the limit groove 940. The limit protrusion 3301 may slide along the extension direction of the limit groove 940 to allow relative rotation of the pivot base 912 and the speaker component 3. The ends of the limit groove 940 are used to limit the limit protrusion 3301 from sliding and thus limiting the relative rotation of the pivot base 912 and the speaker component 3.

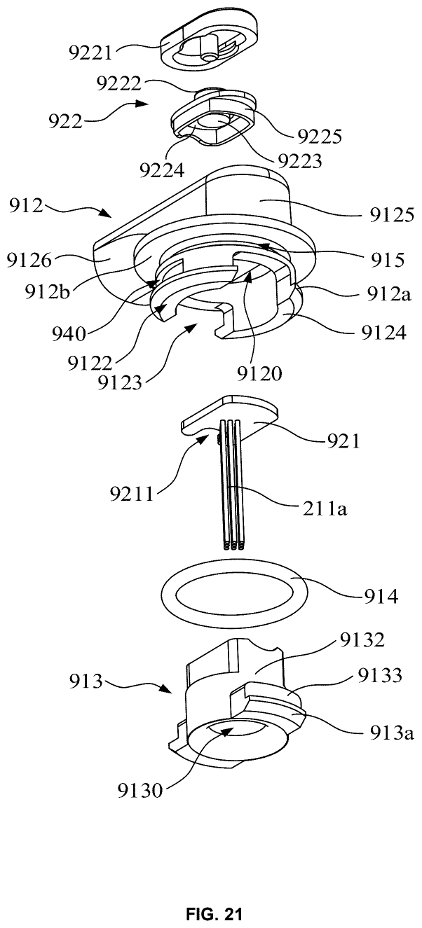

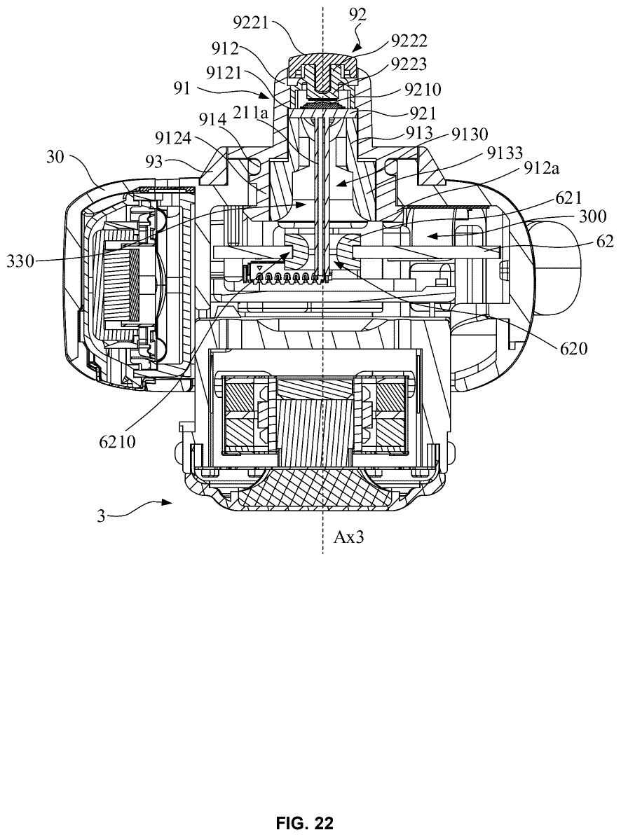

In some embodiments, as shown in FIG. 15, FIG. 20 to FIG. 22, the pivot base 912 is provided with an assembly hole 9120 that extends along the preset axis Ax3, and a support flange 9121 is protrudingly provided on the inner wall of the assembly hole 9120. One end of the pivot bracket 913 extends into the assembly hole 9120. The button circuit board 921 is supported between the support flange 9121 and one end of the pivot bracket 913. The switch 9210 is disposed on the side of the button circuit board 921 that is opposite the accommodation space 300, and the button 922 is accommodated within the assembly hole 9120 and against the switch 9210.

The provision of the assembly hole 9120 facilitates contact between the button circuit board 921 and the button 922. By accommodating the button 922 in the assembly hole 9120, the stick microphone component 7 can be made compact, and at the same time, the assembly hole 9120 can limit the button 922, thus facilitating the assembly of the button 922. Providing the support flange 9121 increases the contact area between the pivot base 912 and the button circuit board 921, enhances the supporting and fixing effect of the pivot base 912 on the button circuit board 921, and thus improves the structural stability.

In some embodiments, as shown in FIG. 15, FIG. 20 to FIG. 22, the button 922 includes a button cap 9221 and an elastic contact member 9222, the elastic contact member 9222 is disposed within the assembly hole 9120 and fixedly supported on the side of the support flange 9121 away from the button circuit board 921, and the elastic contact member 9222 abuts against the switch 9210. The button cap 9221 is provided on the side where the elastic contact member 9222 backs away from the switch 9210 and is exposed via the assembly hole 9120. The support flange 9121 is provided in a ring shape around the preset axis Ax3. The elastic contact member 9222 is integrally molded on the support flange 9121 along the annular direction of the support flange 9121 to block the assembly hole 9120 at the support flange 9121.

The button cap 9221 is exposed to allow for easy pressing by the user. The elastic contact member 9222 is elastic, and the button cap 9221 may transfer the pressing action to the button circuit board 921 via the elastic contact member 9222 to trigger the switch 9210. By setting the support flange 9121 to support the elastic contact member 9222, the contact area between the pivot base 912 and the elastic contact member 9222 can be increased, which facilitates installation of the button cap 9221 and the elastic contact member 9222, and also facilitates the elastic contact member 9222 to block the assembly hole 9120.

By integrally molding the elastic contact member 9222 onto the support flange 9121 in an annular direction along the support flange 9121, the elastic contact member 9222 can be made to have a good sealing of the assembly hole 9120 to prevent the intrusion of water and dust into the interior of the shell assembly 30, which is also conducive to simplifying the structure. In some embodiments, the elastic contact member 9222 is integrally molded onto the support flange 9121 in an annular direction along the support flange 9121 by means of secondary injection molding or compression molding, etc.

In some embodiments, as shown in FIG. 15, FIG. 20 to FIG. 22, the elastic contact member 9222 includes a contact column 9223, an annular sealing portion 9224 surrounding and connected to the contact column 9223, and a cylindrical sealing portion 9225 connected to a side of the annular sealing portion 9224 facing the button circuit board 921 and surrounding the contact column 9223. The annular sealing portion 9224 is supported on the support flange 9121 and sealingly connected to the support flange 9121, and the cylindrical sealing portion 9225 extends to an inner annular surface of the support flange 9121 and is sealingly connected to the inner annular surface of the support flange 9121. The two ends of the contact column 9223 are in contact with the button cap 9221 and the switch 9210, respectively.

The mounting of the elastic contact member 9222 is facilitated by setting the annular sealing portion 9224 to be supported on the support flange 9121. By providing the cylindrical sealing portion 9225 to extend to an inner annular surface of the support flange 9121, the contact area between the pivot base 912 and the elastic contact member 9222 can be increased, and the pivot base 912 and the elastic contact member 9222 can be made to sealingly abut at different locations which can improve the sealing effect of the elastic member on the assembly hole 9120. By setting the contact column 9223, the pressing action from the button cap 9221 can be focused on the contact column 9223, and the pressing action can be more centrally transmitted to the switch 9210, which is conducive to a sensitive response of the switch 9210 to the pressing action of the user.

In some embodiments, as shown in FIG. 15, FIG. 20 to FIG. 22, the pivot bracket 913 is provided with a wiring hole 9130 extending along the preset axis Ax3, and one side of the button circuit board 921 faces the wiring hole 9130. The wiring hole 9130 and the assembly hole 9120 are connected to each other. The speaker component 3 includes a control circuit board 62 connected with a wire harness 211a, and the control circuit board 62 is provided in the accommodation space 300 and disposed opposite the pivot hole 330. The wire harness 211a is connected to the button circuit board 921 along the preset axis Ax3 through the wiring hole 9130.

The arrangement of the wire harness 211a can be facilitated by providing the wiring hole 9130 to realize the electrical connection between the stick microphone component 7 and the control circuit board 62. The wiring hole 9130 and the assembly hole 9120 may be connected to each other along the preset axis Ax3 direction to allow the wire harness 211a to extend along the preset axis Ax3 direction and the preset axis Ax3 to be near to or pass through the wire harness 211a. When the stick microphone component 7 rotates, the wire harness 211a rotates substantially on the preset axis Ax3 or rotates with a smaller radius, thereby reducing the pulling and twisting effect of the stick microphone component 7 on the wire harness 211a and increasing the service life of the wire harness 211a.

In some embodiments, as shown in FIG. 15, FIG. 20 to FIG. 22, the control circuit board 62 is provided with a wire passing hole 620 extending along the preset axis Ax3, the wire passing hole 620 is arranged opposite to the wiring hole 9130, and the wire harness 211a extends from a side of the control circuit board 62 away from the pivot hole 330 into the wiring hole 9130 through the wire passing hole 620 along the preset axis Ax3. The speaker component 3 includes an elastic ring 621, the elastic ring 621 is secured in the wire passing hole 620, and the wire harness 211a is passed through the elastic ring 621. For example, the elastic ring 621 may be a rubber ring.

The wire passing hole 620 is available for the wire harness 211a to pass through, so that the wire passing hole 620 can restrict the wire harness 211a, and by setting the wire passing hole 620 opposite the wiring hole 9130, it is beneficial for the wire harness 211a to extend along the preset axis Ax3 to improve the stability of the connection structure of the wire harness 211a with the control circuit board 62.

The elastic ring 621 has elasticity, and the elastic ring 621 can be elastically deformed when the wire harness 211a moves with respect to the elastic ring 621, which can reduce the resistance to movement of the wire harness 211a while limiting the wire harness 211a, and also prevent the edge of the wire passing hole 620 from scratching the wire harness 211a.

In some embodiments, as shown in FIG. 15, FIG. 20 to FIG. 22, the elastic ring 621 is provided with an annular embedding groove 6210 along a circumferential direction of the elastic ring, and a portion of the control circuit board 62 located outside the wire passing hole 620 is embedded in the annular embedding groove 6210, such that the elastic ring 621 is clamped to the control circuit board 62.

By setting the portion of the control circuit board 62 located outside the wire passing hole 620 to be embedded in the annular embedding groove 6210, the connection structure between the elastic ring 621 and the control circuit board 62 can be simplified, the assembly and connection of the elastic ring 621 with the control circuit board 62 can be facilitated, and the connection stability between the elastic ring 621 and the control circuit board 62 can be improved.

In some embodiments, as shown in FIG. 15, FIG. 20 to FIG. 22, the pivot base 912 includes an end portion 9122 extending into the pivot hole 330 and/or the accommodation space 300, the end portion 9122 is provided with at least two slots 9123 spaced apart along a circumferential direction. The at least two slots 9123 divide the end portion 9122 into at least two elastic arms 9124 spaced apart from each other along the circumferential direction. The pivot bracket 913 includes a shaft body 9132 and at least two blocks 9133 protruding from a periphery of the shaft body 9132, the shaft body 9132 is inserted into the assembly hole 9120 and located between the at least two elastic arms 9124, and the at least two blocks 9133 are embedded in the at least two slots 9123 in a one-to-one correspondence, so as to be supported between two adjacent elastic arms 9124 in corresponding slots 9123.

The elastic arms 9124 are elastic and can undergo elastic deformation. By providing the slot 9123, the elastic arm 9124 can be made to be easily deformed during assembly to make the pivot base 912 easy to assemble. The shaft body 9132 and the at least two blocks 9133 may support and limit the at least two elastic arms 9124, limiting the deformation of the elastic arms 9124 after assembly to improve the structural stability. By embedding the at least two blocks 9133 one-to-one in the at least two slots 9123, the pivot base 912 and the pivot bracket 913 can be made to remain fixed relative to each other, so that the pivot base 912 and the pivot bracket 913 can synchronously rotate about the preset axis Ax3.

In some embodiments, as shown in FIG. 15, FIG. 20 to FIG. 22, outer surfaces of the at least two blocks 9133 are respectively provided with a first stop rim 913a protruding therefrom. The outer surfaces of ends of the at least two elastic arms 9124 away from the button module 92 are respectively provided with a second stop rim 912a protruding therefrom. The first stop rim 913a and the second stop rim 912a are complementarily arranged along a circumferential direction of the shaft body 9132 and abut against a side wall of the shell assembly 30 facing the accommodation space 300 at a periphery of the pivot hole 330.

Through the elastic deformation of the elastic arm 9124, the second stop rim 912a can reach the periphery of the pivot hole 330 through the pivot hole 330 and abut against the side wall of the shell assembly 30 toward the accommodation space 300 during assembly to allow the pivot base 912 to snap-fit with the shell assembly 30 to facilitate assembly of the pivot base 912. The shaft body 9132 and the at least two blocks 9133 can support and limit the at least two elastic arms 9124, limiting the deformation of the elastic arms 9124 away from the shell assembly 30 after assembly to improve structural stability.

By providing the first stop rim 913a, the shell assembly 30 can support the pivot bracket 913, thereby facilitating the installation of the pivot bracket 913. By setting the first stop rim 913a and the second stop rim 912a complementarily along the circumferential direction of the shaft body 9132, the pivot mechanism 91 can be made compact and space-saving.

In some embodiments, as shown in FIG. 15, FIG. 20 to FIG. 22, a periphery of the pivot base 912 is provided with an annular third stop rim 912b protruding therefrom, and the first stop rim 913a and the third stop rim 912b are spaced apart along the preset axis Ax3. The third stop rim 912b abuts against another side wall of the shell assembly 30 away from the accommodation space 300.

In this way, the second stop rim 912a and the third stop rim 912b may be spaced apart along the preset axis Ax3. The third stop rim 912b may play a positioning role during the assembly process, restricting the continued movement of the pivot base 912 in the direction of the accommodation space 300 after the pivot base 912 has been inserted into the pivot hole 330 in place, to facilitate the assembly of the pivot base 912, and improving the structural stability of the assembled structure.

In some embodiments, as shown in FIG. 15, FIG. 20 to FIG. 22, the pivot mechanism 91 includes a sealing ring 914, a periphery of the pivot base 912 is provided with an annular ring groove 915 along the circumferential direction of the pivot base 912, the annular ring groove 915 is spaced apart from the at least two slots 9123 along the preset axis Ax3. The sealing ring 914 is sleeved on the pivot base 912 and abuts between the pivot base 912 and a hole wall of the pivot hole 330.

The annular ring groove 915 may be configured to restrict the sealing ring 914 from sliding after installation. By sleeving the sealing ring 914 on the pivot base 912 and abutting between the pivot base 912 and the hole wall of the pivot hole 330, a seal can be made between the hole wall of the pivot base 912 and the pivot hole 330 to prevent water and dust from intruding into the interior of the shell assembly 30. By spacing the annular ring groove 915 from the at least two slots 9123 along the preset axis Ax3, interference with the sealing effect of the annular ring groove 915 by the formation of the slots 9123 can be reduced.

In some embodiments, as shown in FIG. 15, FIG. 19 to FIG. 21, the pivot base 912 is provided with a splice hole, the stick assembly 70 is provided with a splice portion, and the splice portion is inserted into the splice hole. A bottom wall of the splice hole is provided with a wire hole 912c connected to the assembly hole 9120. The pivot bracket 913 is provided with a first notch 9134 at an end of the pivot bracket 913 for supporting the button circuit board 921, and the button circuit board 921 is provided with a second notch 9211 connected to the first notch 9134. The wire harness 211a includes a wire 211 for leading to the stick assembly 70, and the wire 211 is led from a side of the button circuit board 921 away from the switch 9210 to the splice hole through the first notch 9134 and the second notch 9211, and then to the stick assembly 70.

The splice portion may be the above-described second splice block 74, and the splice hole may be the above-described second splice hole 910. The assembly and connection of the pivot base 912 and the stick assembly 70 can be facilitated by placing the splice portion in the splice hole. Through the wire 211, the control circuit board 62 or the button circuit board 921 can control the operating state of the stick assembly 70. By providing the wire hole 912c in the bottom wall of the splice hole, the wire 211 may extend from within the assembly hole 9120 to the wire hole 912c and through the wire hole 912c to within the splice hole, thereby reducing a lead path length of the wire 211. By providing the first notch 9134 and the second notch 9211 for the wire 211 to accommodate the wire 211, the structure of the pivot mechanism 91 can be simplified, it is easy to line up the wire 211, and it can reduce the pulling on the wire 211.

In some embodiments, as shown in FIG. 15, FIG. 20 to FIG. 22, the speaker component 3 includes an annular light guide 93 disposed around the pivot hole 330, a portion of the annular light guide 93 extends into the accommodation space 300. The speaker component 3 includes a control circuit board 62 disposed within the accommodation space 300, and the control circuit board 62 is provided with a light-emitting element 622, the light-emitting element 622 is configured to emit light, and the annular light guide is configured to transmit the light emitted by the light-emitting element 622 to the exterior of the shell assembly 30.

The light ray may serve to prompt the user. By setting the annular light guide 93 around the pivot hole 330, the light-emitting range can be made larger, the prompts are more eye-catching, and it is easy for the user or others to observe the light, and it can be made possible to make the annular light guide 93 close to the button module 92, which can also reduce the space occupied by the button module 92 and the annular light guide 93, make the structure more compact, and at the same time facilitate the button circuit board 921 and the light-emitting element 622 to be connected to the control circuit board 62 in a compact manner, and reduce the length of the wiring.

Furthermore, the annular light guide 93 being provided around the pivot hole 330 allows for the light-emitting element 622 to be structurally compactly lined up with the wire 211 connecting the stick microphone component 7 on the control circuit board 62.

In some embodiments, as shown in FIG. 15, FIG. 20 to FIG. 22, the annular light guide 93 includes an annular light guide body 931 and a light guide column 932 connected to the annular light guide body 931, and a side of the shell assembly 30 away from the accommodation space 300 is provided with an annular groove 340 surrounding the pivot hole 330 and spaced from the pivot hole 330. The shell assembly 30 is provided with a light guide hole 341 on a bottom wall of the annular groove 340 for connecting the annular groove 340 to the accommodation space 300, the annular light guide body 931 is embedded in the annular groove 340, the light guide column 932 is passed through the light guide hole 341, and the light-emitting element 622 is configured to emit light at least toward the light guide column 932.

By providing the annular groove 340, the assembly and fixation of the annular light guide 93 on the shell assembly 30 can be facilitated. The light guide column 932 can be used to propagate light, and by threading the light guide column 932 through the light guide hole 341, it is possible to enable the light to be propagated from the interior of the shell assembly 30 to the exterior of the shell assembly 30. Using the light guide column 932, the shell assembly 30 can limit the annular light guide 93, which is conducive to a stable connection between the annular light guide 93 and the shell assembly 30.

In some embodiments, the light guide column 932 and the light guide hole 341 can be tightly fitted, and the connection of the annular light guide 93 with the shell assembly 30 can be realized by the light guide column 932 being threaded in the light guide hole 341.

In some embodiments, the number of light guide columns 932 may be set to a plurality. The cross-section of the light guide column 932 perpendicular to the preset axis Ax3 may be cylindrical or curved along the circumferential direction of the pivot hole 330.

In some embodiments, as shown in FIG. 15, FIG. 20 to FIG. 22, the pivot base 912 includes a main shaft base 9125 and a connection portion 9126 protruding from an periphery of the main shaft base 9125, the connection portion 9126 is provided with a splice hole, the stick assembly 70 is provided with a splice portion, the splice portion is inserted into the splice hole. The main shaft base 9125 may be partially inserted into the pivot hole 330. The assembly and connection of the pivot base 912 to the stick assembly 70 is facilitated by placing the splice portion within the splice hole.

The splice portion may be the above-described second splice block 74, and the splice hole may be the above-described second splice hole 910. The connection portion 9126 forms a stop for the annular light guide body 931 in the direction of the preset axis Ax3. In this way, the annular light guide body 931 can be prevented from detaching from the annular groove 340 in the direction of the preset axis Ax3, which is conducive to improving the structural stability of the annular light guide 93.

In some embodiments, the stick microphone component 7 includes the microphone assembly 80, as shown in FIG. 15, FIG. 20 to FIG. 22. The microphone assembly 80 is fixedly connected to an end of the stick assembly 70 away from the speaker component 3. The microphone assembly 80 includes the housing 81 and the microphone 82. The microphone 82 is electrically connected to the control circuit board 62 via the wire 211. The control circuit board 62 is configured to control the light-emitting element 622 to emit light when the microphone 82 is in a pickup state.

The microphone assembly 80 captures sounds from the human mouth to pick up the voice of the user. The stick assembly 70 may be coupled between the microphone assembly 80 and the speaker component 3, and by controlling the movement of the stick assembly 70, the microphone assembly 80 may be controlled to assume different positions and postures. For example, at the end of use of the microphone assembly 80, the microphone assembly 80 can be driven away from the sound pickup area and closer to the wearing component 2 by controlling the movement of the stick assembly 70, causing the microphone assembly 80 to be in a stowed position.

The microphone 82 is in the pickup state when it is turned on, and the microphone 82 is able to work. By configuring the control circuit board 62 to control the light-emitting element 622 to emit light when the microphone 82 is in the pickup state, an outside party can confirm whether the microphone 82 is turned on.

Furthermore, the intensity or color of the light emitted by the light-emitting element 622 after the microphone 82 picks up the voice of the user may change as compared to a situation where the microphone 82 does not pick up the voice of the user. In some embodiments, the light-emitting element 622 is configured such that the intensity or color of the emitted light changes depending on the volume of the voice of the user. In some embodiments, the light-emitting element 622 communicates a message to the outside world by adjusting the flashing frequency.

In some embodiments, a user may make a phone call via the earphone 1, and the light-emitting element 622 may illuminate to indicate that an active call.

In some embodiments, the light-emitting element 622 may illuminate to indicate that the microphone assembly 80 is in an open state or a closed state. The light-emitting element 622 may also illuminate to indicate the switching of the microphone 82. The light-emitting element 622 may illuminate to indicate that the earphone 1 is playing music or is in a mute state.

The foregoing is only a part of the embodiments of the present disclosure, and is not intended to limit the scope of protection of the present disclosure, and any equivalent device or equivalent process transformations utilizing the contents of the specification of the present disclosure and the accompanying drawings, or directly or indirectly utilizing them in other related technical fields. All of them are similarly included in the scope of patent protection of this application.

1. An earphone, comprising a wearing component, a speaker component, and a stick microphone component, wherein
the wearing component is connected to the speaker component,
the stick microphone component is rotatably disposed on the speaker component around a preset axis,
wherein the speaker component includes a shell assembly and a speaker, the shell assembly is provided with an accommodation space and a pivot hole connecting the accommodation space, the speaker is provided within the accommodation space,
the stick microphone component includes a button module, a stick assembly, and a pivot mechanism, the pivot mechanism is threaded through the pivot hole and rotatable around the preset axis relative to the shell assembly,
the pivot mechanism includes a pivot base and a pivot bracket, the pivot base and the pivot bracket are assembled along the preset axis, a portion of the pivot base is disposed outside of the shell assembly and is connected to the stick assembly,
the button module includes a button circuit board and a button, the button circuit board is sandwiched between the pivot base and the pivot bracket, the button circuit board is provided with a switch, and the button is provided on the pivot base for pressing the switch;
a rotation angle of the stick assembly in the rotation direction is in a range of 0˜135°.

2-13. (canceled)

14. The earphone of claim 1, wherein the pivot base is configured to be assembled to the shell assembly from the outside of the shell assembly and is partially disposed within the pivot hole, and the pivot bracket is configured to be assembled with the pivot base within the accommodation space so that the pivot base is maintained in the pivot hole.

15. The earphone of claim 1, wherein
the pivot base is provided with an assembly hole extending along the preset axis, and a support flange is provided protruding from an inner wall of the assembly hole, an end of the pivot bracket extends to the assembly hole,
the button circuit board is supported between the support flange and the end of the pivot bracket,
the switch is located on a side of the button circuit board away from the accommodation space, and the button is accommodated within the assembly hole and abuts against the switch.

16. The earphone of claim 15, wherein
the button includes a button cap and an elastic contact member, the elastic contact member is disposed within the assembly hole and fixedly supported on a side of the support flange away from the button circuit board, the elastic contact member abuts the switch,
the button cap is disposed on a side of the elastic contact member away from the switch and exposed through the assembly hole,
the support flange is provided in an annular shape around the preset axis, and
the elastic contact member is integrally molded on the support flange along an annular direction of the support flange to block the assembly hole at the support flange.

17. The earphone of claim 16, wherein
the elastic contact member includes a contact column, an annular sealing portion surrounding and connected to the contact column, and a cylindrical sealing portion connected to a side of the annular sealing portion facing the button circuit board and surrounding the contact column,
the cylindrical sealing portion is supported on the support flange and is sealingly connected to the support flange, the cylindrical sealing portion extends to an inner annular surface of the support flange and is sealingly connected to the inner annular surface of the support flange, and
two ends of the contact column abut the button cap and the switch respectively.

18. The earphone of claim 15, wherein
the pivot bracket is provided with a wiring hole extending along the preset axis, and one side of the button circuit board faces the wiring hole,
the wiring hole and the assembly hole are connected to each other,
the speaker component includes a control circuit board connected with a wire harness, the control circuit board is provided in the accommodation space and opposite to the pivot hole, and the wire harness is connected to the button circuit board along the preset axis through the wiring hole.

19. The earphone of claim 18, wherein
the control circuit board is provided with a wire passing hole extending along the preset axis, the wire passing hole is arranged opposite to the wiring hole, the wire harness extends from a side of the control circuit board away from the pivot hole into the wiring hole through the wire passing hole along the preset axis,
the speaker component includes an elastic ring, the elastic ring is secured in the wire passing hole, and the wire harness is passed through the elastic ring.

20. The earphone of claim 19, wherein the elastic ring is provided with an annular embedding groove along a circumferential direction of the elastic ring, and a portion of the control circuit board located outside the wire passing hole is embedded in the annular embedding groove, such that the elastic ring is clamped to the control circuit board.

21. The earphone of claim 15, wherein
the pivot base includes an end portion extending into the pivot hole and/or the accommodation space, the end portion is provided with at least two slots spaced apart along a circumferential direction, the at least two slots divides the end portion into at least two elastic arms spaced apart from each other along the circumferential direction,
the pivot bracket includes a shaft body and at least two blocks protruding from a periphery of the shaft body, the shaft body is inserted into the assembly hole and located between the at least two elastic arms, and the at least two blocks are embedded in the at least two slots in a one-to-one correspondence, so as to be supported between two adjacent elastic arms in corresponding slots.

22. The earphone of claim 21, wherein
outer surfaces of the at least two blocks are respectively provided with a first stop rim protruding therefrom,
outer surfaces of ends of the at least two elastic arms away from the button module are respectively provided with a second stop rim protruding therefrom, and
the first stop rim and the second stop rim are complementarily arranged along a circumferential direction of the shaft body and abut against a side wall of the shell assembly facing the accommodation space at a periphery of the pivot hole.

23. The earphone of claim 22, wherein a periphery of the pivot base is provided with an annular third stop rim protruding therefrom, the first stop rim and the third stop rim are spaced apart along the preset axis, and the third stop rim abuts against another side wall of the shell assembly away from the accommodation space.

24. The earphone of claim 22, wherein the pivot mechanism includes a sealing ring, a periphery of the pivot base is provided with an annular ring groove along the circumferential direction of the pivot base, the annular ring groove is spaced apart from the at least two slots along the preset axis, and the sealing ring is sleeved on the pivot base and abuts between the pivot base and a hole wall of the pivot hole.

25. The earphone of claim 18, wherein
the pivot base is provided with a splice hole, the stick assembly is provided with a splice portion, and the splice portion is inserted into the splice hole,
a bottom wall of the splice hole is provided with a wire hole connected to the assembly hole,
the pivot bracket is provided with a first notch at an end of the pivot bracket for supporting the button circuit board, the button circuit board is provided with a second notch connected to the first notch,
the wire harness includes a wire for leading to the stick assembly, and the wire is led from a side of the button circuit board away from the switch to the splice hole through the first notch and the second notch, and then to the stick assembly.

26. The earphone of claim 1, wherein
the speaker component includes an annular light guide disposed around the pivot hole, a portion of the annular light guide extends into the accommodation space,
the speaker component includes a control circuit board disposed within the accommodation space, the control circuit board is provided with a light-emitting element, the light-emitting element is configured to emit light, and the annular light guide is configured to transmit the light emitted by the light-emitting element to the outside of the shell assembly.

27. The earphone of claim 26, wherein
the annular light guide includes an annular light guide body and a light guide column connected to the annular light guide body,
a side of the shell assembly away from the accommodation space is provided with an annular groove surrounding the pivot hole and spaced from the pivot hole,
the shell assembly is provided with a light guide hole on a bottom wall of the annular groove for connecting the annular groove to the accommodation space,
the annular light guide body is embedded in the annular groove, the light guide column is passed through the light guide hole, and the light-emitting element is configured to emit light at least toward the light guide column.

28. The earphone of claim 27, wherein the pivot base includes a main shaft base and a connection portion protruding from an outer periphery of the main shaft base, the connection portion is provided with a splice hole, the stick assembly is provided with a splice portion, the splice portion is inserted into the splice hole, and the connection portion forms a stopper for the annular light guide body in a direction of the preset axis.

29. The earphone of claim 26, wherein the stick microphone component includes a microphone assembly, the microphone assembly is fixedly connected to an end of the stick assembly away from the speaker component, the microphone assembly includes a housing and a microphone, the microphone is electrically connected to the control circuit board through a wire, and the control circuit board is configured to control the light-emitting element to emit light when the microphone is in a pickup state.

30. The earphone of claim 14, wherein
the stick assembly is provided with a limit groove, the limit groove extends along a rotation direction of the stick assembly, the speaker component is provided with a limit protrusion, the limit protrusion is slidably inserted into the limit groove, and two ends of the limit groove are configured to restrict the limit protrusion from sliding and thus limiting a relative rotation of the stick assembly and the speaker component.

31. The earphone of claim 16, wherein
the elastic contact member is integrally molded onto the support flange in the annular direction of the support flange by means of secondary injection molding or compression molding.

32. The earphone of claim 27, wherein
the light guide column and the light guide hole is tightly fitted, and a connection of the annular light guide with the shell assembly is realized by the light guide column being threaded in the light guide hole.
